(19) United States
(12) Patent Application Publication
(10) Pub. No.: US 2008/0121582 A1
(43) Pub. Date: May 29, 2008

(54) FILTER RECYCLING UNIT

(75) Inventor: Michael A. Morris, Rancho Palos Verdes, CA (US)

Correspondence Address: KNOBBE MARTENS OLSON & BEAR LLP, 2040 MAIN STREET, FOURTEENTH FLOOR, IRVINE, CA, 92614, US

(73) Assignee: GEO Plastics, Los Angeles, CA (US)

(21) Appl. No.: 11/765,391

(22) Filed: Jun. 19, 2007

Related U.S. Application Data
(63) Continuation-in-part of application No. 29/250,711, filed on Nov. 28, 2006, now Pat. No. D562429.

(51) Int. Cl. B01D 29/00

(52) U.S. Cl. 210/455

(57) ABSTRACT

A filter recycling unit includes a reservoir defining a cavity capable of storing fluid and at least a portion of a filter, at least one filter positioning member capable of positioning the filter at least partially within the cavity to drain fluid from the positioned filter into the reservoir; and a cover operably connectable to the reservoir. The cover is configured to at least temporarily store the positioned filter and is configured to substantially preclude the drained fluid in the reservoir from spilling during movement of the unit. The cover connected to the reservoir collectively defines a shape for the unit substantially similar to the filter.

### CROSS-REFERENCE TO RELATED APPLICATIONS

This application is a continuation-in-part of, and claims a priority benefit under 35 U.S.C. §120 to, U.S. Application Ser. No. 29/250,711, filed Nov. 28, 2006, entitled “Oil Filter Recycling Reservoir,” which is incorporated herein by reference in its entirety.

### BACKGROUND

1. Field

This invention relates generally to devices for draining fluid, and more particularly to filter recycling units.

2. Description of the Related Art

Each year, the United States generates 425 million used automotive oil filters, as well as numerous used oil filters from other types of engines as a result of regular engine maintenance. New products (e.g., the Drainer Container™, available from GEO Plastics of Los Angeles, Calif.) have led to increased recycling of used oil. However, consumers continue to improperly and illegally dispose of used oil filters. For example, used oil in a Drainer Container™ may be taken to a local service station, but the used oil filter might be disposed of in a local landfill or other locations not intended as disposal sites. When removed from engines, used oil filters can contain more than 45% used motor oil containing measurable quantities of heavy metals. Improper disposal of used oil filters is thus potentially harmful to groundwater, soil, flora, fauna, and the atmosphere.

### SUMMARY

In certain embodiments, a filter recycling unit comprises a reservoir defining a cavity capable of storing fluid and at least a portion of a filter, at least one filter positioning member capable of positioning the filter at least partially within the cavity to drain fluid from the positioned filter into the reservoir; and a cover operably connectable to the reservoir. The cover is configured to at least temporarily store the positioned filter and is configured to substantially preclude the drained fluid in the reservoir from spilling during movement of the unit. The cover connected to the reservoir collectively defines a shape for the unit substantially similar to the filter.

In certain embodiments, a filter recycling unit comprises a first substantially cylindrical reservoir, a first pedestal, a first substantially cylindrical cover, a first sealing member disposed between the first reservoir and the first cover, a second substantially cylindrical reservoir, a connecting member coupling the first reservoir to the second reservoir, a second pedestal, a second substantially cylindrical cover, and a second sealing member disposed between the second reservoir and the second cover. The first substantially cylindrical reservoir defines a first cavity capable of storing fluid and at least a portion of a first filter. The first reservoir includes an open top and external threads. The first pedestal is configured to be at least partially inserted into a center hole of the first filter to drain the fluid from the first filter. The first pedestal extends within the first cavity and including a frustro-conical portion including a plurality of fluid channels. The fluid channels are configured to direct the fluid from the first filter positioned by the first pedestal into the first reservoir. The first substantially cylindrical cover includes an open bottom and internal threads that operably engage the external threads of the first reservoir. The first sealing member substantially precludes fluid drained into the first reservoir from flowing out of the open top of the first reservoir when the first cover is engaged with the first reservoir. The second substantially cylindrical reservoir defines a second cavity capable of storing fluid and at least a portion of a second filter. The second reservoir includes an open top and external threads. The second pedestal is configured to be at least partially inserted into a center hole of the second filter to drain the fluid from the second filter. The second pedestal extends within the second cavity and including a frustro-conical portion including a plurality of fluid channels, the fluid channels configured to direct the fluid from the second filter positioned by the second pedestal into the second reservoir. The second substantially cylindrical cover includes an open bottom and internal threads that operably engage the external threads of the second reservoir. The second sealing member substantially precludes fluid drained into the second reservoir from flowing out of the open top of the second reservoir when the second cover is engaged with the second reservoir.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

These and other features, aspects, and advantages of the invention disclosed herein are described below with reference to the drawings of certain embodiments, which are intended to illustrate and not to limit the invention.

FIG. 1A is a perspective view of an example oil filter.

FIG. 1B is a bottom perspective view of an example oil filter.

FIG. 1C is a partial cutaway view of an example oil filter.

FIG. 2 is a perspective view of an example embodiment of a device for draining fluid.

FIG. 3A is a front elevational view of the device for draining fluid of FIG. 2.

FIG. 3B is a side elevational view of the device for draining fluid of FIG. 2.

FIG. 3C is a top plan view of the device for draining fluid of FIG. 2.

FIG. 3D is a bottom plan view of the device for draining fluid of FIG. 2.

FIG. 4 is an exploded perspective view of the device for draining fluid of FIG. 2.

FIG. 5A is a front elevational view of the reservoir of the device for draining fluid of FIG. 2.

FIG. 5B is a side elevational view of the reservoir of the device for draining fluid of FIG. 2.

FIG. 5C is a top plan view of the reservoir of the device for draining fluid of FIG. 2.

FIG. 5D is a perspective view of an example embodiment of a filter positioning member of the device for draining fluid of FIG. 2.

FIG. 5E is a cross-sectional view of the reservoir of the device for draining fluid of FIG. 2 taken along the line 5E-5E of FIG. 5C.

FIG. 5F is a cross-sectional view of the reservoir of the device for draining fluid of FIG. 2 taken along the line 5F-5F of FIG. 5C.

FIG. 6A is a side elevational view of the cap of the device for draining fluid of FIG. 2.

FIG. 6B is a top plan view of the cap of the device for draining fluid of FIG. 2.

FIG. 6C is a bottom perspective view of the cap of the device for draining fluid of FIG. 2.

FIG. 6D is a cross-sectional view of the cap of the device for draining fluid of FIG. 2 taken along the line 6D-6D of FIG. 6B.

FIG. 7 is a front elevational view of the device for draining fluid of FIG. 2 having a filter mounted therein.

FIG. 8A is a cross-sectional view of the device for draining fluid of FIG. 2 taken along the line 8-8 of FIG. 3C and having a filter mounted therein.

FIGS. 8B and 8C are partial cross-sectional views of the device for draining fluid of FIG. 2 taken along the line 8-8 of FIG. 3C and each having a filter tiltedly mounted therein.

FIG. 9A illustrates an upper surface of a device for draining fluid in spaced proximate relationship with a lower surface of another device for draining fluid.

FIG. 9B illustrates an upper surface of a device for draining fluid in an engaged relationship with a lower surface of another device for draining fluid.

FIG. 9C is a perspective view of a plurality of devices for draining fluid in stacked relation.

FIG. 9D is a perspective view of a plurality of devices for draining fluid in cross-stacked relation.

FIG. 9E is a perspective view of a plurality of devices for draining fluid in another cross-stacked relation.

FIG. 10 illustrates a cross-section of another example embodiment of a device for draining fluid.

FIG. 11A illustrates a cross-section of yet another example embodiment of a device for draining fluid.

FIGS. 11B-11D illustrate cross-sections of examples embodiment of filter positioning devices insertable in the device for draining fluid of FIG. 11A.

FIGS. 12A and 12B illustrate cross-sections of other example embodiments of devices for draining fluid.

FIG. 13 illustrates a cross-section of still another example embodiment of a device for draining fluid.

FIG. 14 illustrates cross-section of yet still another example embodiment of a device for draining fluid.

FIG. 15 illustrates a perspective view a further example embodiment of a yet device for draining fluid.

FIG. 16 illustrates a perspective view of another example embodiment of a cap of a device for draining fluid.

### DETAILED DESCRIPTION OF THE PREFERRED EMBODIMENTS

Although certain preferred embodiments and examples are disclosed below, it will be understood by those in the art that the invention extends beyond the specifically disclosed embodiments and/or uses of the invention and obvious modifications and equivalents thereof Thus, it is intended that the scope of the invention herein disclosed should not be limited by the particular disclosed embodiments described below.

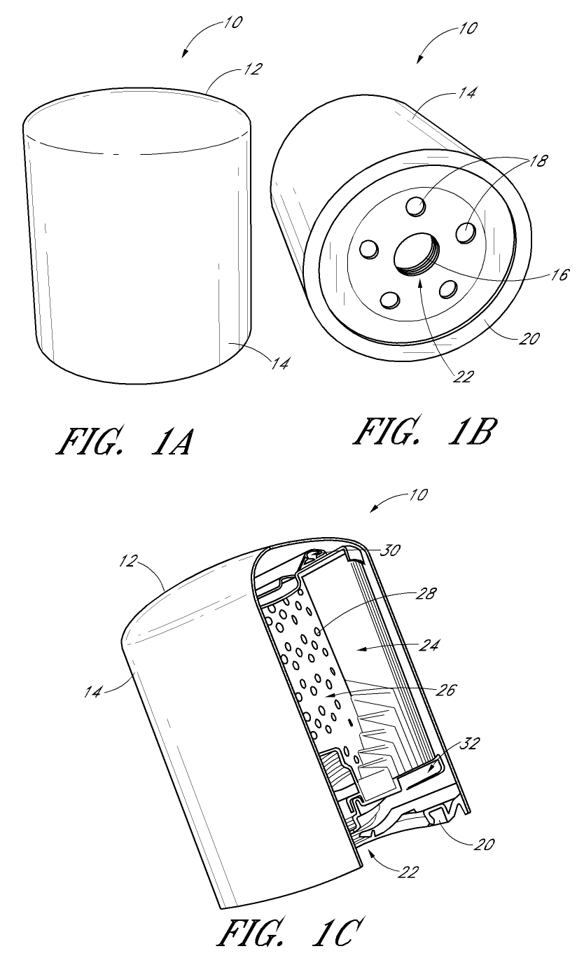

FIG. 1A illustrates a perspective view of an example filter 10. The filter 10 comprises a metallic shell having a cylindrical portion 14 and a top 12. The top 12 is typically domed such that the filter 10 can withstand high pressures. Some filters 10 have an engagement element such as a nut coupled to the top 12. FIG. 1B illustrates a bottom perspective view of the filter 10. The bottom of the filter 10 includes a center hole 16 and a plurality of outer holes 18. The bottom of the filter 10 also comprises a gasket 20 to sealingly engage the filter 10 with an engine. The center hole 16 comprises threads 22 to threadably couple the filter 10 to an engine. When the filter 10 is coupled to an engine, oil typically flows into the plurality of outer holes 18, through the interior of the filter 10, and out the center hole 16. Thus, the outer holes 18 are generally in fluid communication with an oil inlet and the center hole 16 is generally in fluid communication with an oil outlet. The portion of the engine to which the threads 22 of the center hole 16 is mechanically coupled sealingly isolates the outlet from the inlet, and the gasket 20 sealingly isolates the inlet from the ambient environment.

FIG. 1C illustrates a partial cut-away view of the filter 10. The filter 10 comprises filter media 24 such as folded paper or synthetic media configured to trap contaminants within oil passing therethrough. Oil flows through the media 24 and into an inner core 26 through a plurality of apertures 28 in the inner core 26. Oil may then flow out of the filter 10 through the center hole 16. In order to ensure that the filter media 24 is properly positioned within the filter 10, a leaf-spring 30 is commonly used to bias the filter media 24 from the inside of the top 12. An anti-drainback valve 32 can be used to prevent oil from flowing out of the inlet (e.g., draining into the crankcase of an engine) when there is not a positive pressure differential between the inlet and the outlet. Although discussed herein in terms of oil filters for engines such as automobile, truck, farm equipment, and the like, it will be appreciated that the devices for draining fluid described herein may be used to drain fluid from any filter having at least somewhat similar features.

When a filter 10 is removed from an engine (e.g., because the filter media 24 becomes clogged or because the fluid flowing therethrough becomes dirty or contaminated), an amount of fluid remains in the filter 10, for example in the inner core 26 and in spacing between the media 24. Prior to recycling and/or transport, the fluid is preferably drained from the filter 10. Allowing fluid to drain from the filter 10 via gravity for at least about 1 hour, 3 hours, 6 hours, 12 hours, or 24 hours can reduce the amount of fluid in the filter 10. For the sake of illustration, the position of a filter 10 is at 0° if the holes 18 are all on the same horizontal plane and the bulk of the filter 10 is above the holes 18 such that fluid can drain out of the filter 10 through the holes 16, 18 via gravity. The position of a filter 10 is at 180° if the holes 18 are all on the same horizontal plane and the bulk of the filter 10 is below the holes 18 such that fluid cannot drain out of the filter 10 through the holes 16, 18 via gravity. The position of a filter 10 is at 90° if the holes 18 are all on the same vertical plane and the bulk of the filter 10 is to the side of the holes 18 such that some fluid can drain out of the filter 10 through the holes 16, 18 via gravity. In some embodiments, allowing fluid to drain from a filter 10 via gravity for at least about 12 hours can reduce the amount of fluid in the filter by about 30% at about 0°, by about 32% at about 30°, by about 28% at about 60°, and by 0% at 180°. In certain embodiments, creating an aperture in the top 12 of the filter 10 can increase the amount of fluid drainable from the filter. In some such embodiments, allowing fluid to drain from a filter 10 having an aperture in the top 12 via gravity for at least about 12 hours can reduce the amount of fluid in the filter by about 65% at about 0°, by about 67% at about 30°, by about 57% at about 60°, and by about 65% at about 180°. When the filter is at 180°, fluid drains out of the aperture in the top 12 rather than out of the holes 16, 18. Longer durations do not necessarily produce even larger volumes of fluid flow from the filter 10, but tilting the filter 10 (e.g., to about 30°) may increase fluid drainage. It will be appreciated that different filters 10 provide different amounts of fluid flow after different amounts of time. The fluid that flows from the filter 10 may be hazardous and/or recyclable such that capturing the fluid is desirable. Additionally, it may be desirable to capture any additional fluid that may be expelled from the filter 10 after an initial draining period (e.g., during transport from a draining site such as a home to a recycling center).

The United States Environmental Protection Agency classifies used oil filters that have been allowed to drain for at least 12 hours and that have had their top 12 punctured as non-hazardous waste suitable for disposal in a landfill. Although not as good for the environment, certain embodiments described herein allow consumers to change their oil, containing the dirty oil in one reservoir, drain oil from the filter 10 for at least about 12 hours in a second reservoir, throw the filter 10 in the garbage, and join the drained oil with the dirty oil in the first reservoir, whereupon the drained and dirty oil may be sent to a recycling center. It will be appreciated that certain jurisdictions (e.g., California) have more stringent standards such that used oil filters are categorized as hazardous waste regardless of drainage time. Certain embodiments described herein allow consumers to more easily transport a used oil filter 10 to a recycling center.

Certain embodiments of the present invention advantageously provide a filter recycling unit that comprises a reservoir and at least one filter positioning member. The reservoir defines a cavity capable of storing fluid and at least a portion of a filter. Fluid from a filter (e.g., an oil filter) is drainable into the reservoir. The filter positioning member is capable of positioning a filter (e.g., an oil filter) in a substantially fixed relation with respect to the reservoir to drain fluid from the positioned filter into the reservoir. In some embodiments, the filter positioning member is capable of positioning a plurality of filters (e.g., oil filters) in a substantially fixed relation with respect to the reservoir to drain fluid from the positioned filters into the reservoir. Positioning one or more filters 10 in a substantially fixed relation with respect to the reservoir of a reservoir may advantageously enhance fluid drainage and may provide a stable apparatus for transporting one or more positioned filter 10 (e.g., to a recycling center).

Consumers are more likely to recycle oil filters when using a proper disposal apparatus, such as the devices for draining fluid described herein. Recycling the used oil filters from automobiles in the United States alone would advantageously result in the recovery of about 160,000 tons of steel and about 18 million gallons of oil (approximately 570,000 barrels).

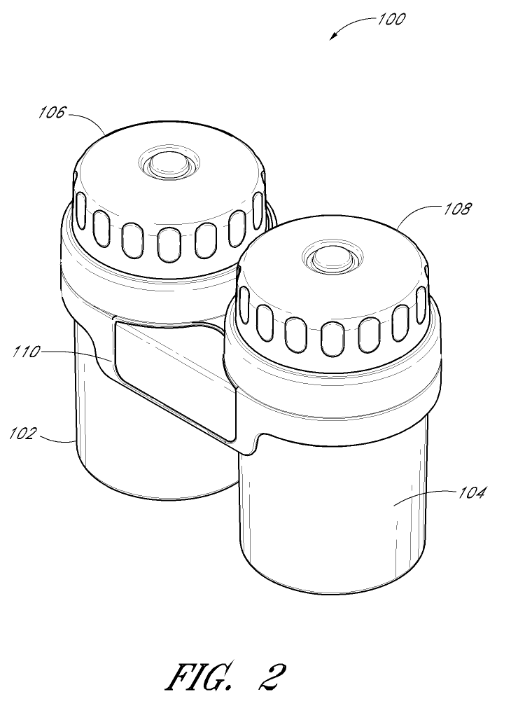

FIGS. 2-8 illustrate of an example embodiment of a filter recycling unit 100. The filter recycling unit 100 comprises a reservoir and a filter positioning member. The reservoir 102 defines a cavity capable of storing fluid and at least a portion of a filter 10. Fluid from a filter 10 is drainable into the reservoir 102. In certain embodiments, the reservoir 102 is configured to at least partially store at least about 50%, 75%, 90%, 95%, or 99% of all oil filters on the market for the engines of light and medium duty cars and trucks. In some embodiments, the reservoir 102 is dimensioned such that a certain percentage of oil filters can be at least partially stored therein. For example, the inner diameter of a cylindrical reservoir 102 may be larger than the outer diameter of a cylindrical filter 10.

In some embodiments, the reservoir 102 comprises hard plastic. In some embodiments, the reservoir 102 comprises high-density polyethylene (HDPE). In some embodiments, the reservoir 102 comprises polypropylene. Other materials or combinations of materials are also possible.

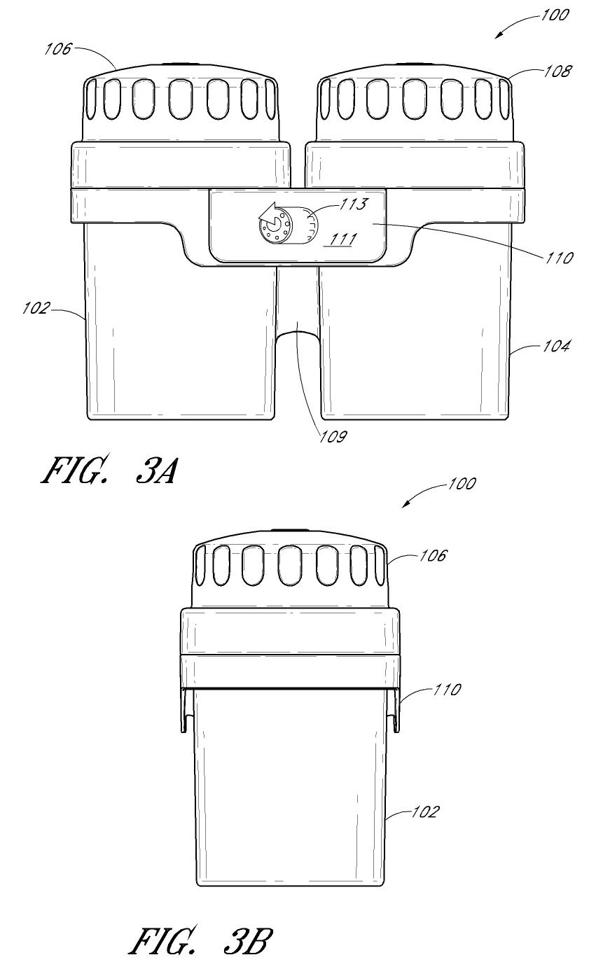

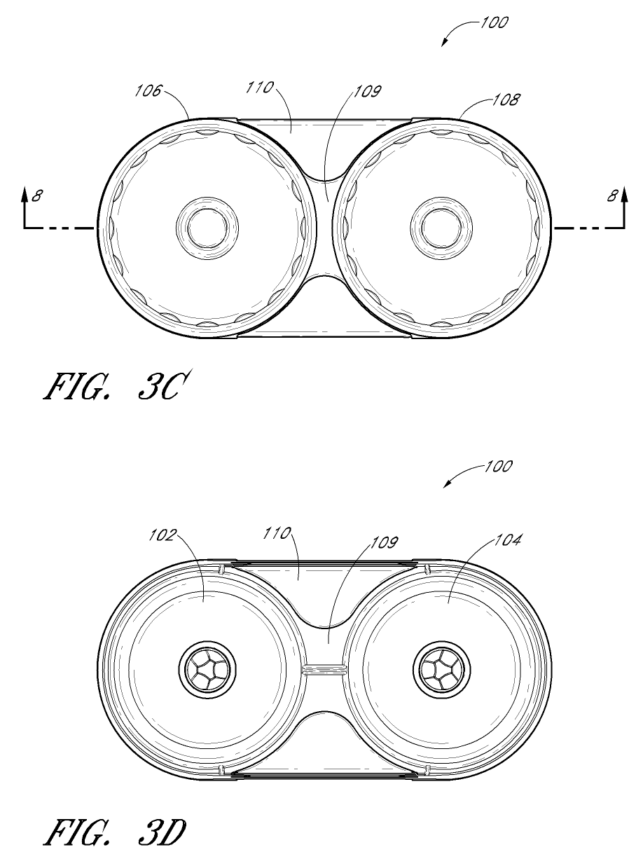

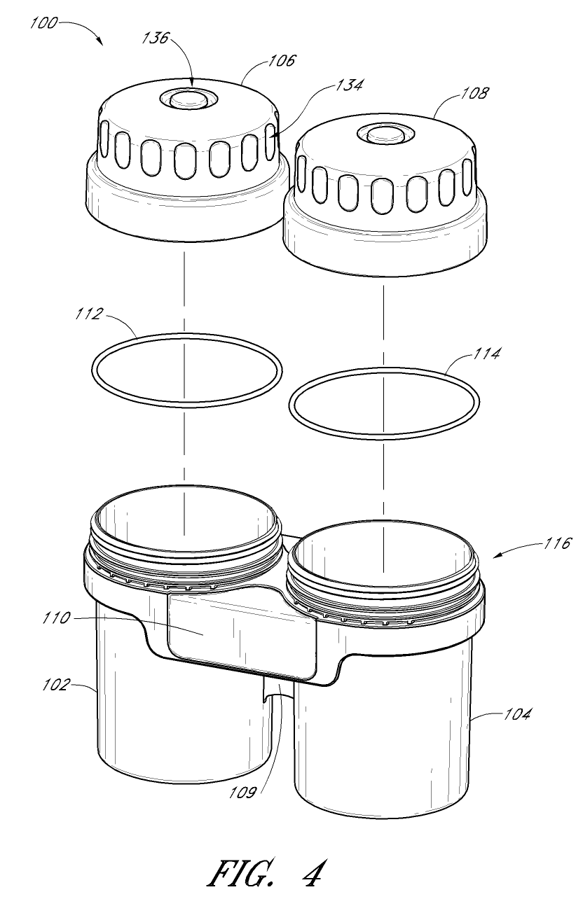

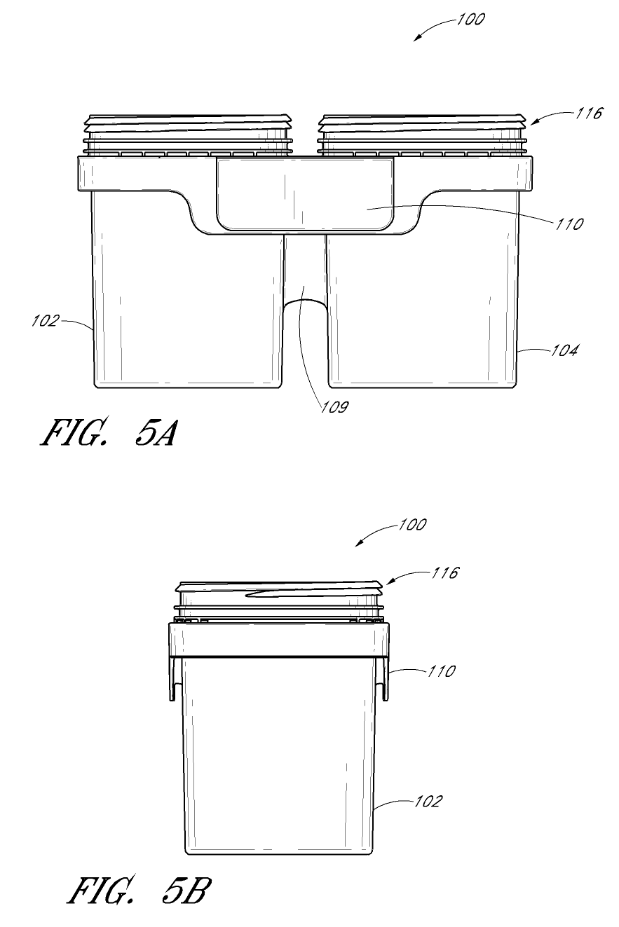

In the embodiment illustrated in FIGS. 2-8, the filter positioning member comprises a pedestal 118, as described in detail below. FIGS. 3A-3D illustrate additional views of the filter recycling unit 100: FIG. 3A is a front elevational view; FIG. 3B is a side elevational view; FIG. 3C is a top plan view; and FIG. 3D is a bottom plan view. The bottom surface of the reservoir 102 is substantially flat such that the filter recycling unit 100 may sit flatly on a shelf, on the ground, etc. In some embodiments, the bottom surface of the reservoir 102 comprises a rubberized surface to reduce sliding.

The illustrated filter recycling unit 100 further comprises an optional cover or cap 106, described in detail below. The cover 106 is operably connectable to the reservoir 102. The cover 106 is configured to at least temporarily store a positioned filter. The cover 106 is configured to substantially preclude (e.g., prevent) fluid drained into the reservoir 102 from spilling.

In certain embodiments, the reservoir and a cover connected to the reservoir collectively defines a shape for the filter recycling unit similar to a filter. As used herein, the phrase “similar to a filter” includes, but is not limited to, having a likeness or resemblance, especially in a general way, to any shape that a filter may take. In some embodiments, the filter recycling unit is shaped so as to approximate the shape of a single filter 10 (e.g., by being substantially cylindrical and having a convex top and a concave bottom, as illustrated by the filter recycling unit 100). Other shapes of filters and filter recycling units are also possible (e.g., polyhedral, hemispherical, combinations thereof, and the like). The shape of the filter recycling unit may be different than the shape of a filter positioned therein. For example, the filter recycling unit may be substantially cylindrical while the filter positioned therein is polyhedral. A wide variety of shapes and combinations of shapes are possible.

The illustrated filter recycling unit 100 further comprises an optional second or “other” fluid reservoir 104 defining a cavity capable of storing fluid and at least a portion of a filter 10. Fluid from a filter 10 is drainable into the reservoir 104. The second reservoir 104 is connected to the reservoir 102, for example by the connecting member 109 described below. The second reservoir 104 may be the same as the reservoir 102 or may be different than the reservoir 102 (e.g., having a different size, having a different shape, comprising a different material, being coupled to a different type of filter positioning member, combinations thereof, and the like). In some embodiments, the reservoir 102 and the reservoir 104 are formed integrally, for example in a blow molding or injection molding process.

In embodiments comprising the second reservoir 104, the filter recycling unit may further comprise a second or “other” filter positioning member. In the illustrated embodiment, the second filter positioning member comprises a pedestal 120, described in detail below. In some embodiments, the filter positioning member may be characterized as the pedestals 118, 120. The second filter positioning member may be the same as the at least one filter positioning member or may be different than the at least one filter positioning member (e.g., having a different size, having a different shape, comprising a different material, operable in a different way, combinations thereof, and the like).

The illustrated filter recycling unit 100 comprises an optional handle 110. The handle 110 is configured such that the filter recycling unit 100 is more easily manipulatable by a person or a machine. Although depicted at a middle portion of the filter recycling unit 100, the handle 110 may be positioned at any suitable location (e.g., on a side of the filter recycling unit 100, on the top of the filter recycling unit 100, and the like). In certain embodiments, the filter recycling unit 100 comprises a plurality of handles 110.

The illustrated fluid reservoirs 102, 104 are mechanically coupled by an optional connecting member 109. In certain embodiments, the connecting member 109 is integrally formed with one or both of the reservoirs 102, 104. In some embodiments, the reservoir 102, the reservoir 104, the connecting member 109, and the handle 110 are formed integrally, for example in a blow molding or injection molding process. In certain embodiments, the handle 110 acts as a connecting member 109.

In certain embodiments, the cavities of the fluid reservoir 102 and the second fluid reservoir 104 are in fluid communication, or the fluid reservoir 102 and the second fluid reservoir 104 share a common cavity. In certain alternative embodiments, the cavities portions of the fluid reservoir 102 and the second fluid reservoir 104 are not in fluid communication. Certain such embodiments allows a user of the filter recycling unit 100 to drain a first type of fluid into the reservoir 102 and a second type of fluid into the reservoir 104. This may be useful, for example, when different types of fluids are contained in different filters 10, for example different types of oil (e.g., having different weights, additives, percentage of synthetic, combinations thereof, and the like). Inhibiting the mixing of fluids from different filters allows different types of fluids to be disposed of differently. As an example, a first positioned filter 10 having used natural 10W-30 can be drained into the cavity of the reservoir 102 and a second positioned filter 10 having used synthetic 10W-40 can be drained into the cavity of the reservoir 104.

The filter recycling unit 100 optionally comprises a label section 111 where a user or a manufacturer may place a label. For example, a manufacturer may include indicia of recycling such as the logo for oil filter recycling 113 (e.g., as depicted in FIG. 3A) or the logo for oil recycling. For another example, a manufacturer may include text such as “Recycle Used Oil Filters” and “Recycle Used Oil.” The label area 111 may also be used to meet certain legal requirements of oil filter recycling units. For example, certain jurisdictions require such units to be labeled “Drained Used Oil Filters” or the like. Additionally, certain jurisdictions require the oil filter recycling unit to be clearly marked with the initial date of accumulation or receipt. Placing the label 111 on the handle 110 conveniently allows reference to the required disposal date, which is typically within 180 days of accumulation or receipt. In certain embodiments, the label area 111 comprises a surface that may be written on by a pen, a marker, a grease pen, or the like. Such a surface may be optionally erased when a filter 10 is removed from the reservoir 102. In certain embodiments, labels attached to the label area 111 may be detached when a filter 10 is removed from the reservoir 102. Although depicted as being on the handle 110, the label area 111 may be on other portions of the filter recycling unit 100. In certain embodiments, the filter recycling unit 100 comprises a plurality of label areas 111.

In certain embodiments, the reservoir 102 optionally comprises a drain, for example, near the bottom, such that fluid drained from a filter 10 may be removed from the reservoir 102 without removing the filter 10 or disconnecting the cover 106. In certain embodiments, the drain comprises an aperture and a plug (e.g., tethered to the reservoir 102). In certain embodiments, the drain comprises a valve or spigot. In some embodiments, the reservoir 102 comprises a spout at an upper surface to allow easier pouring of fluid from the reservoir 102. In some embodiments, the cover 106 comprises a spout at an upper surface to allow easier pouring of fluid from the reservoir 102, either with a filter 10 disposed therein (e.g., having baffles to inhibit fluid from flowing back into the filter 10) or after a filter 10 has been removed (e.g., by placing the cover 106 on a reservoir 102 containing fluid).

In certain embodiments, the volume of the cavity of the reservoir is less than about 65% of the volume of the largest filter 10 that can fit into the filter recycling unit 100. Because much of the volume of the interior of a filter 10 is occupied by the filter media 24, the leaf spring 30, etc., the volume of a filter 10 is actually less than the computed inner volume based on the dimensions of the metal shell. Accordingly, a cavity having a volume less than about 65% may be sufficient to contain all of the fluid that flows from a filter 10. However, other cavity volumes are also possible (e.g., less than about 20%, 25%, 28%, 29%, 30%, 31%, 32%, 40%, 57%, 58%, 59%, 60%, 61%, 62%, 63%, 64%, 66%, 67%, 68%, 69%, 70%, 80%, 100%, 120%, 140%, 160%, 180%, or 200% of the volume of the largest filter 10 that can fit into the filter recycling unit 100). In certain embodiments, the volume of the cavity is less than about 0.1 gallons (approximately 0.4 liters), less than about 0.2 gallons (approximately 0.75 liters), or less than about 0.3 gallons (approximately 1 liter). In certain embodiments, the volume of the reservoir 102 is less than about 0.5 gallons (approximately 2 liters), less than about 0.65 gallons (approximately 2.5 liters), or less than about 0.8 gallons (approximately 3 liters). When the fluid reservoir 102 is in fluid communication with the second fluid reservoir 104, the volume of the cavity may be less than the sum of about 65% of the volume of each filter 10. For example, if the filter recycling unit 100 is configured to hold two filters 10 having the same size, the combined volume of the cavities of the reservoirs 102, 104 could be less than about 130% of the volume of a single filter 10.

In certain embodiments, an optional splash guard may be disposed above the lower surface of a filter 10 positioned in the filter recycling unit 100 such that fluid drained from the filter 10 does not come out of the filter recycling unit 100 upon jostling of the reservoir 10. In some embodiments, the splash guard comprises a one-way valve that allows fluid to flow into the cavity but that does not allow fluid to flow out of the cavity.

In certain embodiments, the filter recycling unit 100 optionally comprises fluid-absorptive media such that fluid in the cavity does not substantially spill out of a tipped-over filter recycling unit 100. The fluid-absorptive media may comprise a sponge, strips of cloth, sand, clay (e.g., bentonite clay), wood shavings, kitty litter (e.g., comprising sodium silicate), and the like.

FIG. 4 illustrates an exploded perspective view of the filter recycling unit 100. The covers 106, 108 are disengaged from the first and second fluid reservoirs 102, 104, revealing that the top of each of the reservoirs 102, 104 optionally includes threads 116 to engage inner threads 122 of the covers 106, 108. The illustrated filter recycling unit 100 further comprises optional sealing elements 112, 114. In some embodiments, the sealing elements 112, 114 comprise O-rings. In certain embodiments, the O-rings 112, 114, are disposed on a bottom portion of the threads 116. Other positions are also possible. For example, in some embodiments, the O-rings 112, 114 may be integrated with an inner surface of the covers 106, 108. 0-rings can help to the covers 106, 108 to sealingly engage the reservoirs 102, 104. Other methods of sealingly engaging a cover 106 onto a reservoir 102 are also possible. For example, Teflon tape may be used between the cover 106 and the reservoir 102. For another example, the cover 106 and the reservoir 102 may be sealable as in Tupperware®.

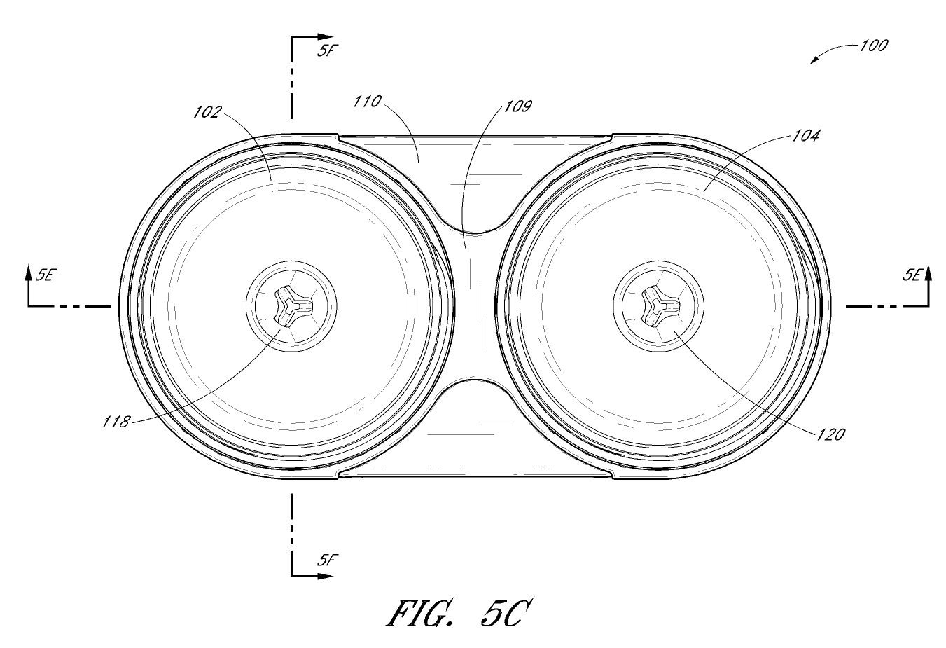

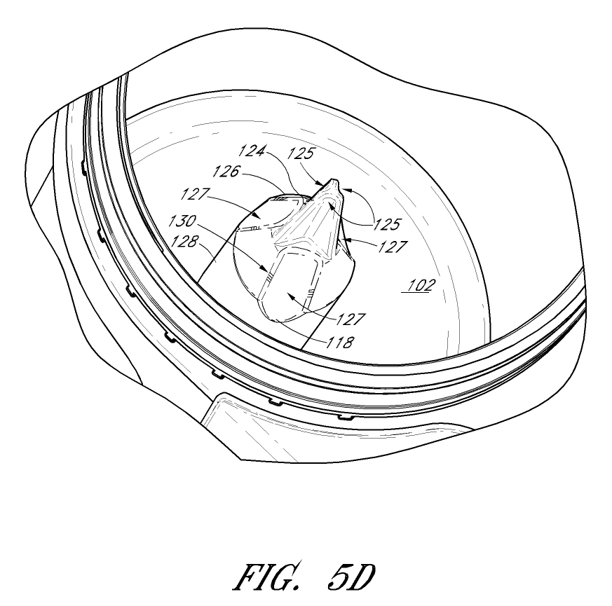

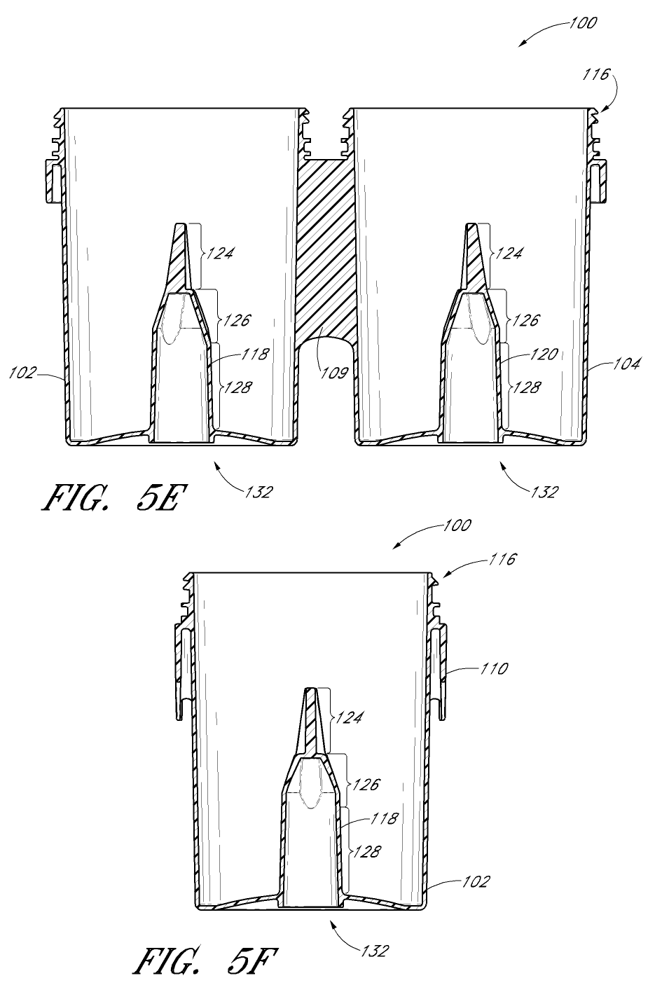

FIGS. 5A-5C further illustrate the reservoirs 102, 104: FIG. 5A is a front elevational view; FIG. 5B is a side elevational view; and FIG. 5C is a top plan view. A bottom plan view would look substantially similar to FIG. 3D. In FIGS. 5A and 5B, external threads 116 are illustrated as being on an upper portion of the reservoirs 102, 104. Other embodiments are also possible. For example, the threads 116 may be internal, may be spaced from the top of the reservoirs 102, 104, and the like. In FIG. 5C, the connecting member 109 connecting the reservoir 102 to the reservoir 104 is a piece of material disposed between the reservoirs 102, 104 that is integrally formed with the reservoirs 102, 104. Other embodiments are also possible. For example, the connecting member 109 may be separately formed, may be disposed around the edges of the reservoirs 102, 104, etc.

FIG. 5D is a perspective view of an inner portion of the reservoir 102 comprising a filter positioning member. In the embodiment illustrated in FIGS. 5C and 5D, the filter positioning member comprises a pedestal 118 configured to be at least partially inserted in a center hole 16 of a filter 10. The pedestal 118 extends generally upwards such that fluid may flow from a positioned filter 10 into the reservoir 102. The pedestal 118 extends from a bottom end of the reservoir 102 towards an upper end of the reservoir 102. In certain embodiments, the pedestal 118 extends from a sidewall of the reservoir 102 towards an upper end of the reservoir 102. In certain embodiments, the pedestal 118 extends from a sidewall of the reservoir 102 and then turns towards an upper end of the reservoir 102. The reservoir 102 and the pedestal 118 are illustrated in cross-section in FIGS. 5E (along the line 5E-5E of FIG. 5C) and 5F (along the line 5F-5F of FIG. 5C).

In some embodiments, the pedestal 118 is integrally formed with the reservoir 102, for example in a blow molding or injection molding process. In certain such embodiments, the pedestal 118 is substantially hollow (as illustrated in FIGS. 2D, 5E, and 5F), for example to reduce the weight of the filter recycling unit 100 and/or the amount of material used to manufacture the filter recycling unit 100. In some embodiments, the pedestal 118 is formed separately from the reservoir 102 and is modular such that different pedestals 118 may be used in different reservoirs 102. In certain such embodiments, the pedestal 118 and/or the reservoir 102 comprise elements to hold the pedestal 118 in a substantially stable position.

In the illustrated embodiment, which includes the second reservoir 104, the filter positioning member may include a second pedestal 120 configured to be at least partially inserted in a center hole 16 of a filter 10. The second pedestal 120 extends generally upwards such that fluid may flow from a positioned filter 10 into the reservoir 104. The illustrated pedestals 118, 120 are substantially symmetrical about the connecting member 109. However, the pedestal 118 may be different than the pedestal 120, or the pedestals 118, 120 may be identical rather than symmetrical.

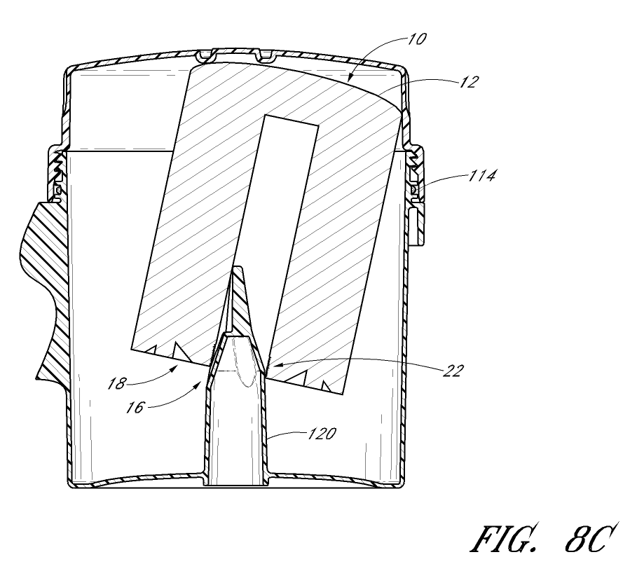

As illustrated in FIGS. 5D-5F, the pedestal 118 has an upper portion 124, a middle portion 126, and a lower portion 128 that are each generally frusto-conically shaped. The upper portion 124 is configured to be at least partially inserted into a center hole 16 of a filter 10 and/or to engage the bottom of the center hole 16. The upper portion 124 may be thinner than the middle portion 126 such that a substantial amount of the upper portion 124 can be inserted into the center hole 16 of a filter 10. In certain such embodiments, the upper portion 124 may be configured to laterally stabilize the filter 10 on the pedestal 118. The middle portion 126 is configured to be at least partially inserted into a center hole 16 of a filter 10 and/or to engage the bottom of the center hole 16, and is configured to allow fluid to flow into the cavity of the reservoir 102. The bottom portion 128 is configured to allow fluid to flow into the cavity and to space the filter 10 from the bottom of the reservoir. As described below with respect to FIGS. 8B and 8C, in some embodiments the shape of the pedestal 118 allows filters 10 at least partially positioned in the reservoir 102 to be tilted.

If a lateral cross-section of the portion of the pedestal 118 that engages the bottom of the center hole 16 has a size and shape that substantially matches the size and shape of the center hole 16, fluid may be occluded from flowing out of the filter 10. In some embodiments, at least a portion of the pedestal 118 comprises a plurality of channels (e.g., the plurality of channels 125 in the upper portion 124 and/or the plurality of channels 127 in the middle portion 126) that allow fluid to flow from the center hole 16 of a filter 10 into the cavity of the reservoir 102 without substantial occlusion. Although illustrated as being triangle-shaped and having three channels 125, 127, it will be appreciated that the pedestal 118 may comprise any number of channels (e.g., being flat-head shaped and having two channels, being plus-shaped and having four channels, etc.). As the number of channels increases, the engagement with the filter 10 increases because there are more portions separating the channels that interact with the center hole 16, but the manufacturing complexity of the pedestal 118 also increases (e.g., by increasing the complexity of creating a mold and increasing the care used when cleaning a mold). The channels 125, 127 may be symmetrically positioned around the center of the pedestal 118 or may be asymmetrically positioned around the center of the pedestal 118. In some embodiments, the channels 125 and/or the channels 127 are created during formation of the pedestal 118 (e.g., as part of a mold). In some embodiments, the channels 125 and/or the channels 127 are created after forming the pedestal 118 (e.g., by removing material from the pedestal 118).

In certain embodiments, the pedestal 118 comprises threads 130 where the center hole 16 of the filter 10 engages the pedestal 118 (e.g., on the outer surfaces of features separating the channels, as illustrated in FIG. 5D). Threads 130 allow a filter 10 to be threadably coupled to the pedestal 118, for example to position the filter 10 in a substantially fixed relation (e.g., a locked relation) with respect to the cavity of the reservoir 102. Locking the filter 10 into place via the pedestal 118 is advantageous when the filter 10 is small in comparison to the reservoir 102 (e.g., when the filter 10 is a motorcycle engine oil filter) and does not touch a sidewall of the reservoir 102. Locking the filter 10 into place via the pedestal 118 can also be advantageous when the filter 10 is small enough that the cover 106 does not engage the top 12 of the filter 10. In certain embodiments, the pedestal 118 comprises a material that is softer than the material of the threads 22 (e.g., a material that is malleable by metal) such that the threads 130 may be formed upon rotation of a filter 10 onto the pedestal 118 accompanied by application of a force to the filter 10. Such an embodiment advantageously provides lockable coupling between the filter 10 and the pedestal 118, even when the pitch of the threads 22 is unknown. However, such an embodiment may be disadvantageous for filter recycling units 100 used for draining multiple filters 10 because the pedestal 118 may become worn with each creation of threads 130.

The second pedestal 120 may be the same as the first pedestal 118 or may be different than the first pedestal 118 (e.g., having a different size, having a different shape, comprising a different number of channels, comprising different or no threads, comprising one or more different materials, combinations thereof, and the like).

In some embodiments, the pedestal 118 comprises a metallic or other hard substance such that the top of the pedestal 118 can pierce or puncture the top 12 of the filter 10 upon application of a force if the filter 10 is placed into the reservoir 102 with the center hole 16 facing away from the pedestal 118 (the “inverted position”). In such embodiments, the pedestal 118 may also or alternatively be configured to be at least partially inserted into the top of a filter 10. A hammer, mallet, hand, or other such striking instrument may be utilized to cause the pedestal 118 to pierce the filter 10. It will be appreciated that draining the filter 10 in an inverted position may be superior to achieve more complete fluid flow from the filter 10. In such embodiments, the pedestal 118 is configured to be inserted into the aperture in the top 12 of the filter 10. In some embodiments, creating an aperture in the top 12 of the filter 10 allows faster drainage of fluid from the filter 10 when the center hold 16 faces down because air may more easily displace the fluid. The pedestal 118 may create an aperture similarly sized and shaped to the portion of the pedestal 118 doing the puncturing, so it may be advantageous to reposition the filter 10 after forming the aperture in the top 12 to allow the fluid to drain from the filter 10. In some embodiments, rotation of the filter 10 via engagement with a rotating cover 106 may cause the aperture to become rounded, thereby achieving repositioning that allows fluid flow without further contact with the filter 10.

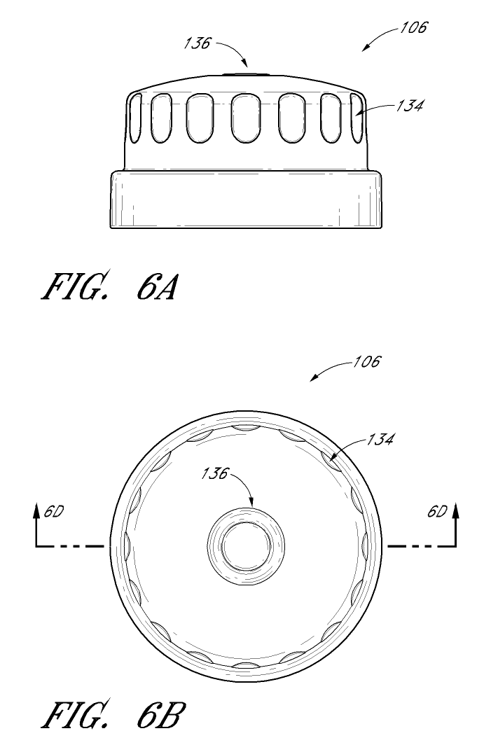

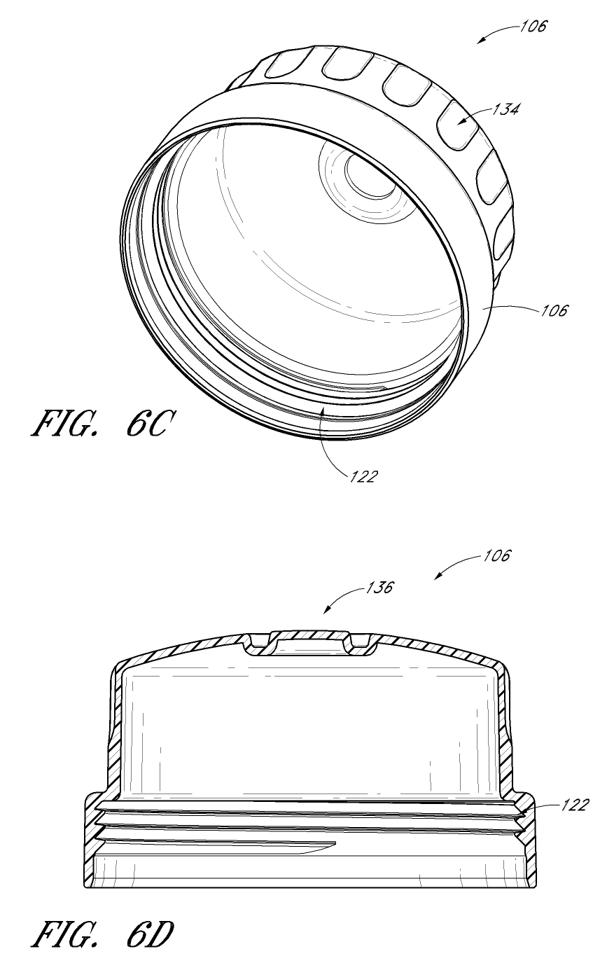

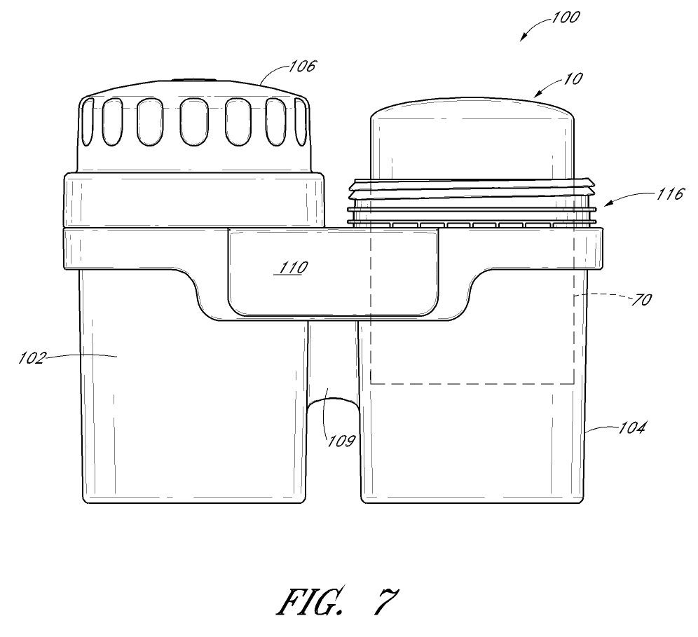

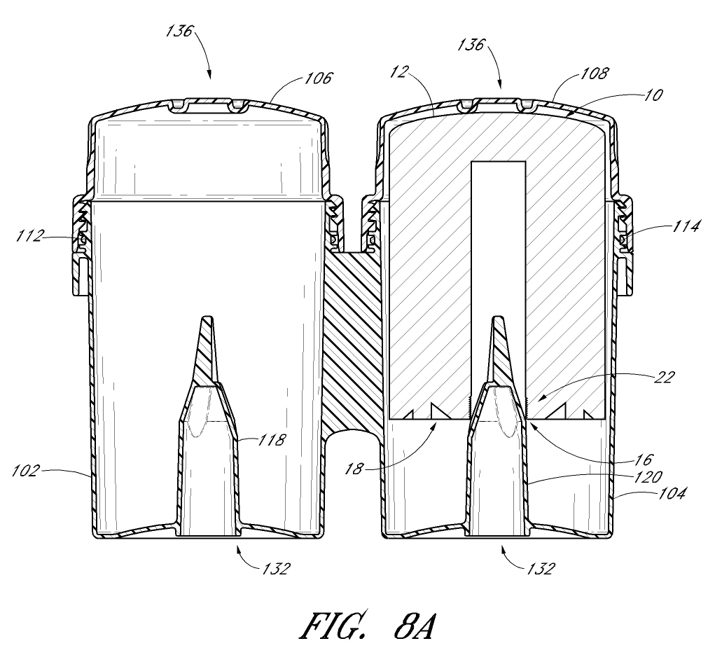

FIGS. 6A-6D further illustrate the cover or cap 106: FIG. 6A is a side elevational view; FIG. 6B is a top plan view; FIG. 6C is a bottom perspective view; and FIG. 6D is a cross-sectional view taken along the line 6D-6D of FIG. 6B. The cover 106 has a closed top, an open bottom, and a side wall between the top and the bottom. The cover 106 may comprise the same material or a different material than the reservoir 102. For example, the cover 106 may comprise hard plastic such as acetyl-based resin, HDPE (e.g., high molecular weight HDPE), LDPE, etc. The filter recycling unit 100 is configured such that the cover 106 can be mounted onto the reservoir 102 while a filter 10 is disposed within the reservoir 102. In some embodiments, the inside of the top of the cover 106 engages the top 12 of a filter 10 in the reservoir 102 to help form a substantially fixed relation between the filter 10 and the cavity of the reservoir 102. In certain such embodiments, the cover 106 may be referred to as part of the filter positioning member.

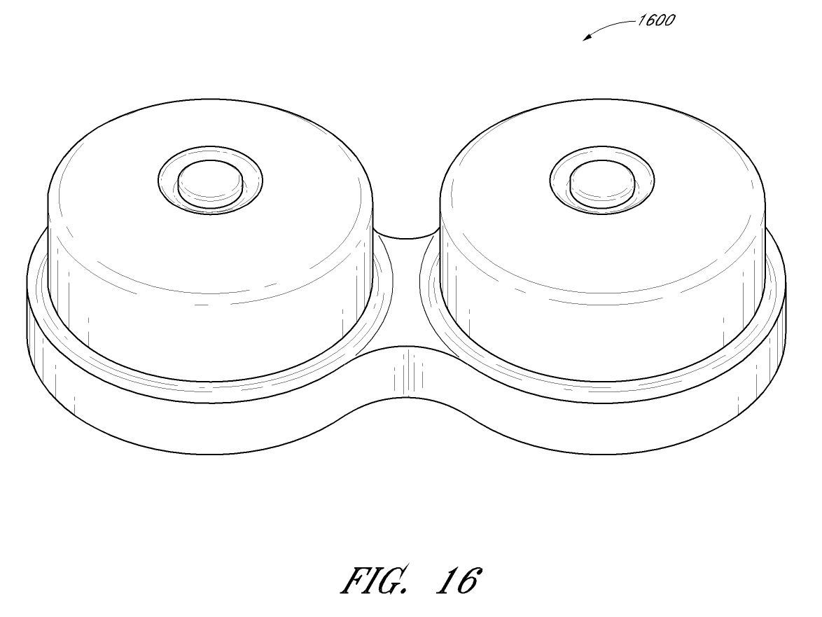

As explained above, when the cover 106 is mounted on the reservoir 102, an o-ring or other type of sealing element 112 aids in the creation of a substantially fluidly sealed engagement therebetween to preclude (e.g., substantially preclude, minimize, prevent) fluid drained into the reservoir 102 from spilling. Together, the cover 106 and the reservoir 102 may create a rainproof, non-leaking, and closed fluid recycling unit 100 suitable for transporting the filter 10. In the illustrated embodiment, the cover 106 comprises a plurality of inner threads 122 that are engageable with (e.g., that complement) the outer threads 116 of the reservoir 102 such that the cover 106 may be screwed onto the reservoir 102. In certain alternative embodiments, the reservoir 102 comprises inner threads and the cover 106 comprises outer threads such that the cover 106 may be screwed onto the reservoir 102. Other embodiments for sealingly mounting the cover 106 on the reservoir 102 are also possible, for example as discussed below with respect to FIG. 16.

The cover 106 optionally comprises a plurality of features 134 configured to enhance the gripability or tactility of the cover 106. In the illustrated embodiment, the features 134 comprise dimples, although the cover 106 may alternatively comprise a textured surface, a rubberized surface, a surface configured to be engaged by a machine or a tool, combinations thereof, and the like. In some embodiments, the cover 106 may be tightened to a fluid-tight seal by hand such that a tool is not required. In some embodiments, an oil filter wrench may be used to tighten the cover 106. Although the features 134 and the threads 122 are illustrated as being in different vertical positions along the cover 106, in some embodiments the features 134 and the threads 122 are at least partially in the same vertical position along the cover 106 (e.g., having dimpled features 134 on the outside and threads 122 on the inside).

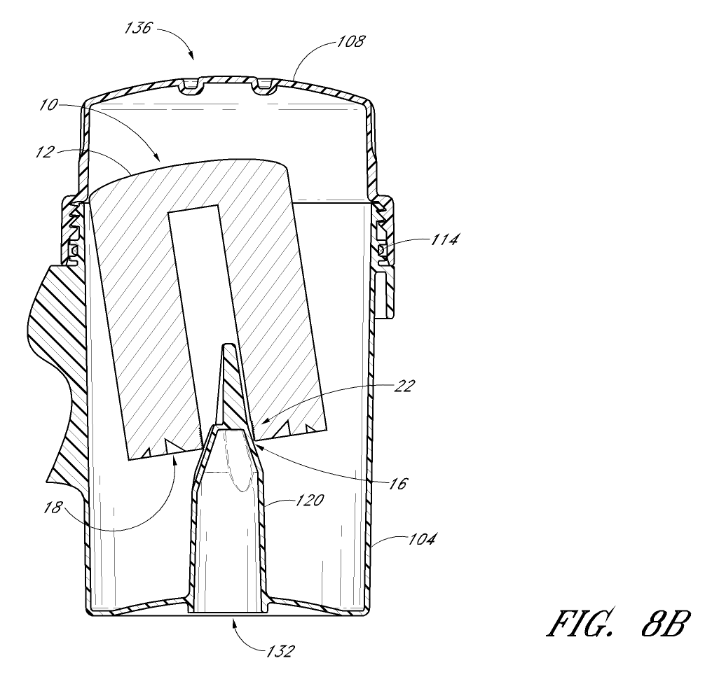

FIG. 7 illustrates the filter recycling unit 100 when a filter 10 is placed in the reservoir 104. The filter 10 protrudes through an upper portion of the reservoir 104, but is spaced from the bottom of the reservoir 104 by the filter positioning member, as illustrated by the dashed line 70 (e.g., by the pedestal 120 engaging the center hole 16 of the filter 10). The cover 106 is mounted on the reservoir 102, for example because a filter 10 is disposed in the reservoir 102 or to prevent fluid from the filter 10 disposed in the reservoir 104 from flowing into the reservoir 102. However, the filter 10 may also be positioned in the reservoir 104 with the cover 106 not on the reservoir 102.

FIG. 8A illustrates a cross-sectional view of the filter recycling unit 100 taken along the line 8-8 of FIG. 3C. As in FIG. 7, a filter 10 is disposed within the reservoir 104. However, the cover 108 has been mounted on the reservoir 104 and engages the o-ring 114. The center hole 16 of the filter 10 is mounted on the pedestal 120 such that the center hole 16 and the outer holes 18 are in spaced relation from the bottom of the reservoir 104. Such an arrangement may allow fluid to drain from the filter 10 into the cavity of the reservoir 104. The filter positioning member comprising the pedestal 120 positions the filter 10 in a substantially fixed relation with respect to the cavity of the reservoir 104 to drain fluid from the filter 10 into the cavity. The top 12 of the filter 10 is in contact with an inner surface of the cover 108. A smaller filter 10 would not be in contact with the inner surface of the cover 108, but may still be positioned in a substantially fixed relation with respect to the cavity of the reservoir 104 due to the filter positioning member comprising the pedestal 120.

Referring again to FIGS. 5E, 5F, and 8A, the cover 106 optionally comprises an upper surface and the reservoir 102 optionally comprises a lower surface. The upper surface of the cover 106 is configured to cooperate with the lower surface of the reservoir 102 such that a plurality of filter recycling units is stackable. Referring again to FIGS. 6B, 6D, and 8A, in embodiments comprising a second reservoir 104, the second cover 108 optionally comprises an upper surface and the second reservoir 104 optionally comprises a lower surface. The upper surface of the second cover 108 is configured to cooperate with the lower surface of the reservoir 104 such that a plurality of filter recycling units 100 is stackable. The upper surfaces of the covers 106, 108 may be the same or different. The lower surfaces of the reservoirs 102, 104 may be the same or different. In embodiments in which the covers 106, 108 have a convex upper surface, the lower surface of the reservoirs 102, 104 may be concave so as to create a larger contact area during engagement. Other embodiments are also possible. For example, each surface having features 132, 136 may be flat, a portion of the lower surface of the reservoirs 102, 104 may be convex while the upper surface of the covers 106, 108 are convex, etc.

FIG. 8B illustrates a partial cross-sectional view of the filter recycling unit 100 taken along the line 8-8 of FIG. 3C. As in FIG. 8A, a filter 10 is disposed within the reservoir 104 and the cover 108 has been mounted on the reservoir 104 and engages the o-ring 114. The center hole 16 of the filter 10 is mounted on the pedestal 120 such that the center hole 16 and the outer holes 18 are in spaced relation from the bottom of the reservoir 104 to allow fluid to drain from the filter 10 into the cavity of the reservoir 104. The filter positioning member comprising the pedestal 120 positions the filter 10 in a substantially fixed relation with respect to the cavity of the reservoir 104 to drain fluid from the filter 10 into the cavity.

The filter 10 illustrated in FIG. 8B is smaller than the filter 10 depicted in FIG. 8A such that the bottom of the positioned filter 10 may be substantially non-parallel or “tilted” with respect to the bottom of the reservoir 104. In some embodiments, the shape of the filter positioning member 120 allows a filter 10 that is at least partially disposed within the reservoir 104 to be tilted between about 5 and 85 degrees, between about 10 and 50 degrees, between about 20 and 40 degrees, between about 25 and 35 degrees, or about 30 degrees. For example, in a portion of the pedestal 120 that has a smaller lateral cross-section that the diameter of the center hole 16, a first side of the pedestal 120 at a first distance from the bottom of the reservoir 104 may contact a first side of the center hole 16 and second side of the pedestal 120 a second distance from the bottom of the reservoir 104 different from the first distance may contact a second side of the center hole 16. As described above, in certain embodiments about 65% of the fluid may be drained from a filter 10 that is positioned about 0° with respect to a bottom of the reservoir 104, but about 67% of the fluid may be drained from a filter 10 that is positioned about 30° with respect to the bottom of a reservoir 104.

In some embodiments, the dimensions of the reservoir 104 are configured to allow a large percentage of filters 10 positioned therein to be tilted. For example, FIG. 8C illustrates a partial cross-sectional view of another filter recycling unit 100 taken along the line 8-8 of FIG. 3C. A filter 10 having substantially the same size as the filter 10 depicted in FIG. 8A is disposed within the reservoir 104 and the cover 108 has been mounted on the reservoir 104 and engages the o-ring 114. The center hole 16 of the filter 10 is mounted on the pedestal 120 such that the center hole 16 and the outer holes 18 are in spaced relation from the bottom of the reservoir 104 to allow fluid to drain from the filter 10 into the cavity of the reservoir 104. The reservoir 104 illustrated in FIG. 8C is larger than the reservoir 104 depicted in FIG. 8A such that the filter 10 may be tilted with respect to the bottom of the reservoir 104. In some embodiments, the shape of the filter positioning member 120 allows a filter 10 that is at least partially disposed within the reservoir 104 to be tilted between about 5 and 85 degrees, between about 10 and 50 degrees, between about 20 and 40 degrees, between about 25 and 35 degrees, or about 30 degrees.

The reservoir 104 illustrated in FIG. 8C includes dimensions such that the filter 10 may be tilted in any direction, but in some embodiments the reservoir 104 is configured such that a filter 10 positioned therein may be tilted in one or a small number of directions. In certain such embodiments, the volume of the reservoir 104 may be advantageously reduced. In certain such embodiments, a cross-section of the reservoir 104 has an elliptical, oval, or rounded rectangular shape. In certain such embodiments, the filter positioning member 120 is not centered within the reservoir 104.

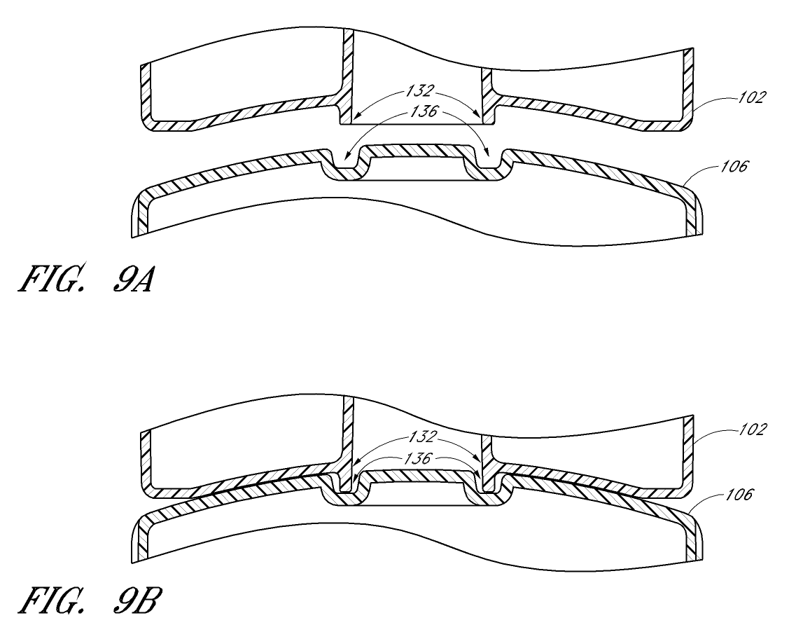

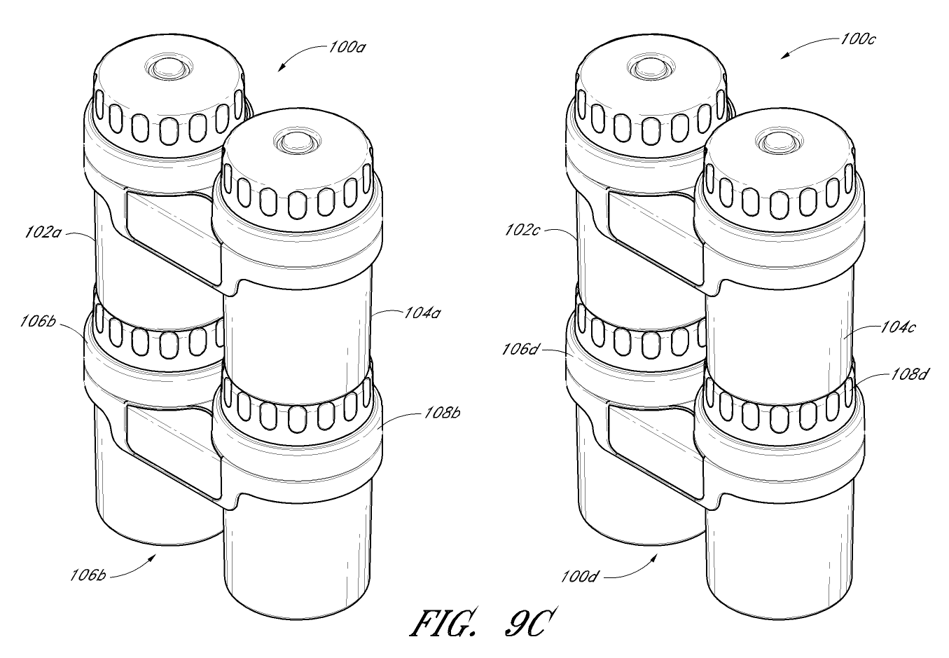

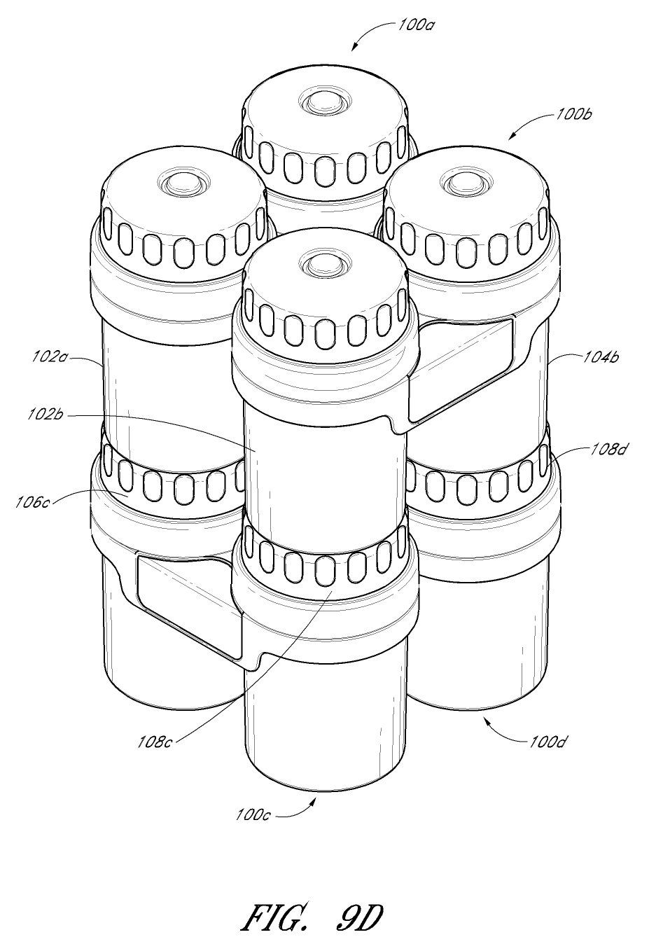

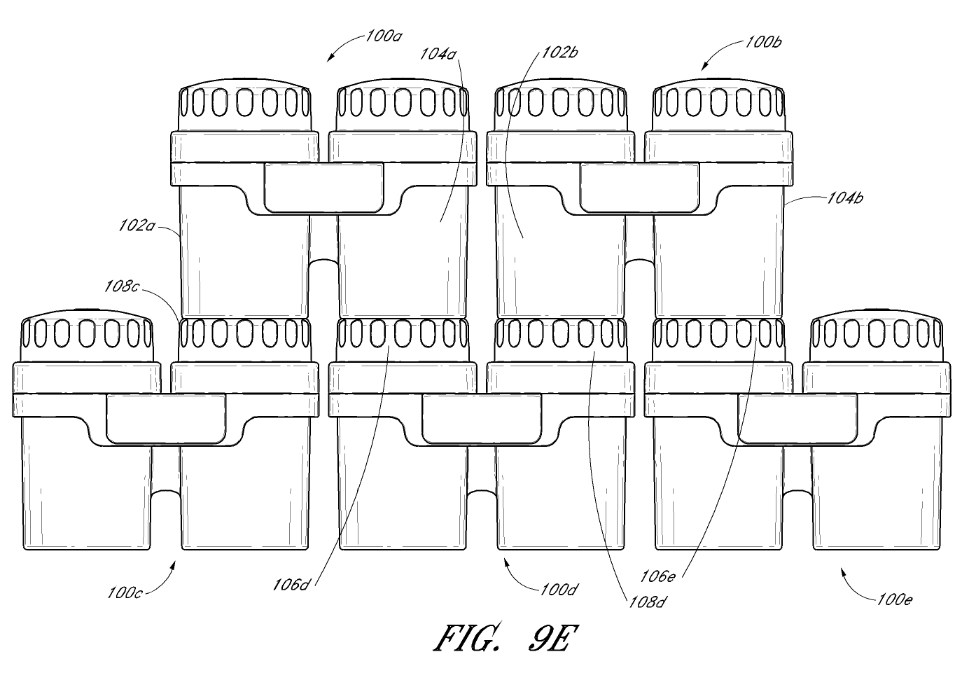

In some embodiments, a lower surface of the reservoirs 102, 104 comprises features 132 is configured to engage an upper surface of a cover 106, 108 and an upper surface of the covers 106, 108 comprises features 136 is configured to engage a lower surface of a reservoir 102, 104 to form a stable stack of units 100. As used herein, the phrase “stable stack” includes, but is not limited to, a stack of filter recycling units having the ability to react to an incidental disturbing force by maintaining position. In some embodiments, a stable stack is a stack that is stable enough to not collapse when a person or machine contacts the stack (e.g., accidentally bumps into the stack). In some embodiments, a stable stack is a stack that is stable enough to be built to a certain height without falling (e.g., to about 4 feet, to about 6 feet, to about 8 feet, to about 10 feet). FIG. 9A illustrates a cross-sectional view of the features 132 on the lower surface of a reservoir 102 proximate to the features 136 on the upper surface of a cover 106. When the reservoir 102 is placed on top of the cover 106, the features 132, 136 are engaged, as depicted in FIG. 9B. Other features on the upper surface of the covers 106, 108 and the lower surface of the reservoirs 102, 104 are also possible. For example, one or both of the features may be textured, ribbed, rubberized, combinations thereof, and the like. Accordingly, a plurality of filter recycling units 100 may be stacked on top of each other with the features 132 engaging the features 136.

FIG. 9C illustrates a first method of stacking a plurality of filter recycling units 100. A filter recycling unit 100a is placed over a filter recycling unit 100b such that the reservoir 102a of the filter recycling unit 100a engages the cover 106b of the filter recycling unit 100b and such that the reservoir 104a of the filter recycling unit 100a engages the cover 108b of the filter recycling unit 100b. A filter recycling unit 100c is placed over a filter recycling unit 100d such that the reservoir 102c of the filter recycling unit 100c engages the cover 106d of the filter recycling unit 100d and such that the reservoir 104c of the filter recycling unit 100c engages the cover 108d of the filter recycling unit 100d. The plurality of stacked filter recycling units 100 is orientable such that the upper surface of the cover 106 of a first filter recycling unit 100 cooperates with the lower surface of the reservoir 102 of a second filter recycling unit 100, the upper surface of the other cover 108 of the first filter recycling unit 100 cooperates with the lower surface of the other reservoir 104 of the second filter recycling unit 100, the upper surface of the cover 106 of a third filter recycling unit 100 cooperates with the lower surface of the reservoir 102 of a fourth filter recycling unit 100, and the upper surface of the other cover 108 of the third filter recycling unit 100 cooperates with the lower surface of the other reservoir 104 of the fourth filter recycling unit 100. This side-by-side and vertical stacking method may be advantageous, for example, for simple stacking of a few filter recycling units 100, but may become unstable if continued to be built vertically.

FIG. 9D shows an alternative method of stacking a plurality of filter recycling units 100. Filter recycling units 100a and 100b are placed over filter recycling units 100c and 100d such that the reservoir 102a of the filter recycling unit 100a engages the cover 106c of the filter recycling unit 100c, such that the reservoir 104a of the filter recycling unit 100a engages the cover 106d of the filter recycling unit 100d (not shown), such that the reservoir 102b of the filter recycling unit 100b engages the cover 108c of the filter recycling unit 100c, and such that the reservoir 104b of the filter recycling unit 100b engages the cover 108d of the filter recycling unit 100d. FIG. 9E shows another alternative method of stacking a plurality of filter recycling units 100. Filter recycling units 100a and 100b are placed over filter recycling units 100c, 100d, and 100e such that the reservoir 102a of the filter recycling unit 100a engages the cover 108c of the filter recycling unit 100c, such that the reservoir 104a of the filter recycling unit 100a engages the cover 106d of the filter recycling unit 100d, such that the reservoir 102b of the filter recycling unit 100b engages the cover 108d of the filter recycling unit 100d, and such that the reservoir 104b of the filter recycling unit 100b engages the cover 106e of the filter recycling unit 100e. The plurality of stacked filter recycling units 100 is orientable such that the upper surface of the cover 106 of a first filter recycling unit 100 cooperates with the lower surface of the reservoir 102 of a second filter recycling unit 100, the upper surface of the other cover 108 of the first filter recycling unit 100 cooperates with the lower surface of the reservoir 102 of a third filter recycling unit 100, the upper surface of the cover 106 of a fourth filter recycling unit 100 cooperates with the lower surface of the other reservoir 104 of the second filter recycling unit 100, and the upper surface of the other cover 108 of the fourth filter recycling unit 100 cooperates with the lower surface of the other reservoir 104 of the fourth filter recycling unit 100. Such interlinked stacking methods may be use advantageous, for example, for stable stacking of large pluralities of filter recycling units 100. It will be appreciated that a wide variety of stacking methods are possible, including combinations of the methods discussed above.

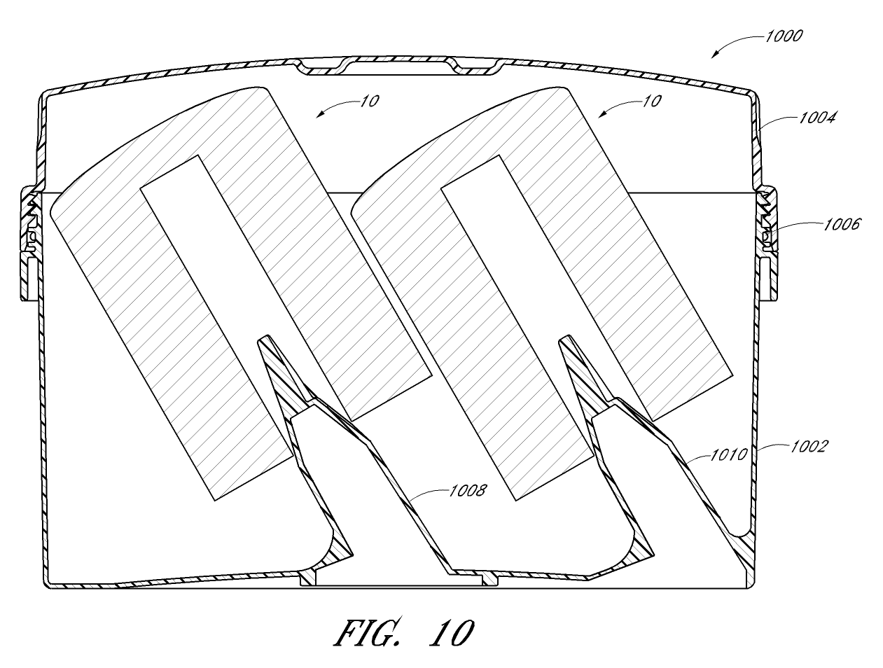

FIG. 10 illustrates a filter recycling unit 1000 for draining fluid. The filter recycling unit 1000 comprises a reservoir 1002 and a filter positioning member. The fluid reservoir 1002 defines a cavity capable of storing fluid and at least a portion of a filter 10. Fluid from a filter 10 is drainable into the cavity of the fluid reservoir 1002. The filter positioning member is capable of positioning a filter 10 at least partially within the cavity to drain fluid from a positioned filter into the reservoir 1002. The filter positioning member comprises a pedestal 1008 and a pedestal 1010. A bottom of a filter 10 positioned on the pedestal 1008 is substantially non-parallel to a bottom of the reservoir 1002, and a bottom of a filter 10 positioned on the pedestal 1010 is substantially non-parallel to a bottom of the reservoir 1002. The pedestals 1008, 1010 are angled with respect to the bottom of the reservoir 1002. In some embodiments, the pedestals 1008, 1010 are angled the same amount. In certain such embodiments, the pedestals 1008, 1020 are angled between about 5 and 85 degrees, between about 10 and 50 degrees, between about 20 and 40 degrees, between about 25 and 35 degrees, or about 30 degrees. Each of the pedestals 1008, 1010 is disposed within a single reservoir 1002 such that fluid draining from the filters 10 may be in fluid communication. Other embodiments are also possible (e.g., comprising a divider such that fluid from each filter 10 drains into a different cavity of the reservoir 1002, comprising angled pedestals in connected first and second reservoirs, etc.). Draining some filters 10 at an angle may result in better fluid flow from the filters 10, for example because air may more quickly displace such fluid within the filters 10. As described above with respect to FIGS. 8B and 8C, filters 10 may also be tilted on filter positioning members that are substantially perpendicular to a bottom of the reservoir.

The filter recycling unit 1000 optionally comprises a cover 1004 connectable to the reservoir 1002 to at least temporarily store a positioned filter 10 and configured to substantially preclude fluid drained into the reservoir 1002 from spilling. In certain such embodiments, the cover 1004 connected to the reservoir 1002 collectively defines a shape for the filter recycling unit 1000 similar to a filter. As described above, the fluid recycling unit may further comprise threads and a sealing element 1006.

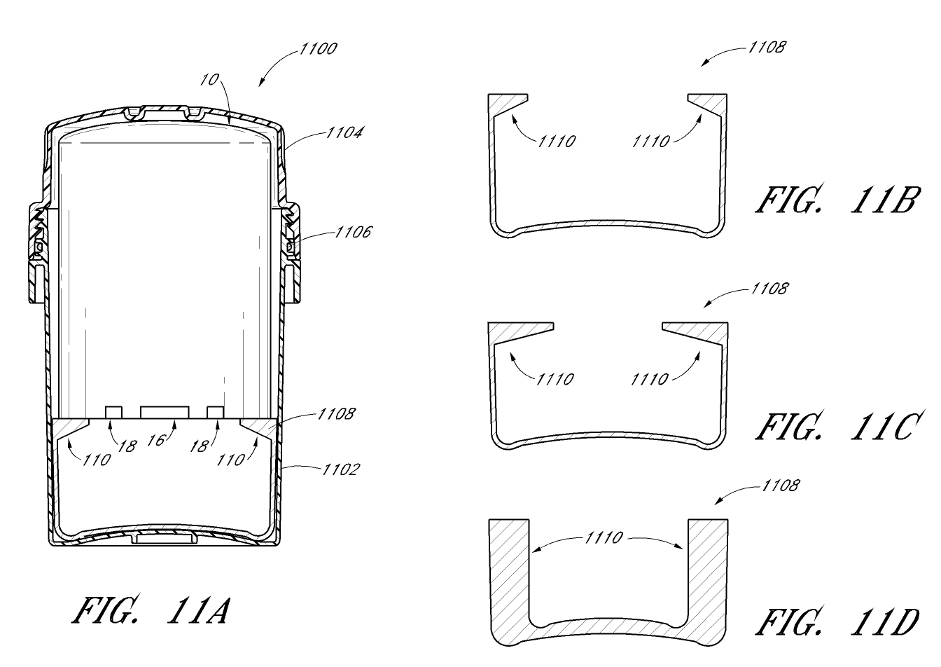

FIG. 11A illustrates a filter recycling unit 1100 for draining fluid. The filter recycling unit 1100 comprises a reservoir 1102 and a filter positioning member. The fluid reservoir 1102 defines a cavity capable of storing fluid and at least a portion of a filter 10. Fluid from a filter 10 is drainable into the cavity of the fluid reservoir 1102. The filter positioning member is capable of positioning a filter 10 at least partially within the cavity to drain fluid from a positioned filter into the reservoir 1102. The filter positioning member 1108 comprises an interior portion of a sidewall of the reservoir 1102. For example, the filter positioning member 1108 illustrated in FIG. 11A comprises a modular support member (e.g., ledge, shelf) 1110 protruding into the cavity and configured to position the filter 10 in a substantially fixed relation with respect to the cavity to drain fluid from the filter 10 into the cavity. In some embodiments, the filter positioning member 1108 is annular about the entire inner surface of the reservoir 1102. In some embodiments, the filter positioning member 1108 is annular about portions of the inner surface of the reservoir 1102 (e.g., comprising a plurality of ridges). The filter positioning member 1108 preferably does not occlude either the outer holes 18 or the center hole 16 of the filter 10 (e.g., as depicted in FIG. 11A).

In some embodiments, the filter positioning member 1108 is not modular with the reservoir 1102. In certain such embodiments, the filter positioning member 1108 is integrally formed with the reservoir 1102. For example, the support member 1110 may be formed extending inwardly from a sidewall of the reservoir 1102. In some embodiments, the filter positioning member 1108 is configured such that a filter 10 at least partially positioned in the reservoir 1102 is tilted with respect to the bottom of the reservoir 1102. For example and without limitation, the filter positioning member 1108 may comprise a first shelf spaced from the bottom of the reservoir 1102 by a first distance and a second shelf spaced from the bottom of the reservoir 1102 by a second distance different that the first distance.

In certain alternative embodiments, the filter positioning member 1108 may be modularly inserted into the reservoir 1102. An advantage of modular filter positioning members 1108 is that a single reservoir 1102 may be used with different filter positioning members 1108 to provide a filter recycling unit 1100 optimizable for any of a plurality of filters 10 having different shapes and sizes. FIGS. 11B-11D illustrate cross-sections of example embodiments of filter positioning members 1108 insertable into the reservoir 1102 of the filter recycling unit 1100. In the filter positioning member 1108 illustrated in FIG. 11B, the ledge 1110 is positioned at a greater distance from the bottom of the filter positioning member 1108 than the ledge 1110 in the filter positioning member 1108 of FIG. 11A, which may be useful for filters 10 that are short and wide. In the filter positioning member 1108 illustrated in FIG. 11C, the ledge 1110 extends inwardly further than the ledge 1110 in the filter positioning member 1108 of FIG. 11A, which may be useful for filters 10 that are tall and thin. In the filter positioning member 1108 illustrated in FIG. 11D, the ledge 1110 extends all the way down to the bottom of the filter positioning member 1108, which may be useful for filters 10 that are heavy. Certain such embodiments may reduce the volume of the cavity available for fluid containment, so the filter positioning member 1108 of FIG. 11D preferably comprises one or a plurality of ridges such that the ledges 1110 are not entirely annular, thereby increasing the volume of the cavity. Another advantage of modular filter positioning members 1108 is that the filter positioning member 1108 removable from the reservoir 1102 may allow easier disposal of fluid that has drained from the filter 10 (e.g., by capping the filter positioning member and removing the fluid still enveloped in the filter positioning member 1108).

The filter recycling unit 1100 optionally comprises a cover 1104 connectable to the reservoir 1102 to at least temporarily store a positioned filter 10 and configured to substantially preclude fluid drained into the reservoir 1102 from spilling. In certain such embodiments, the cover 1104 connected to the reservoir 1102 collectively defines a shape for the filter recycling unit 1100 similar to a filter. As described above, the fluid recycling unit may further comprise threads and a sealing element 1106.

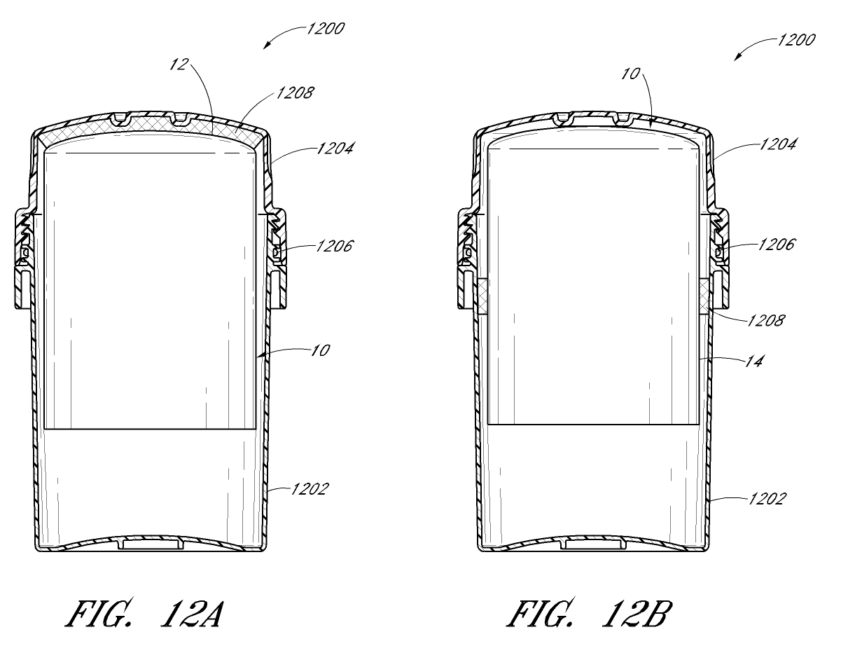

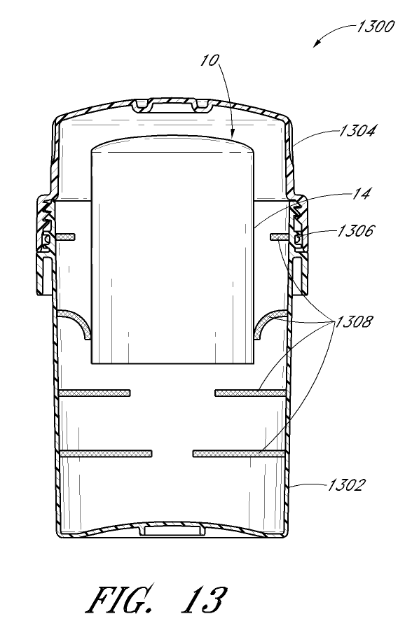

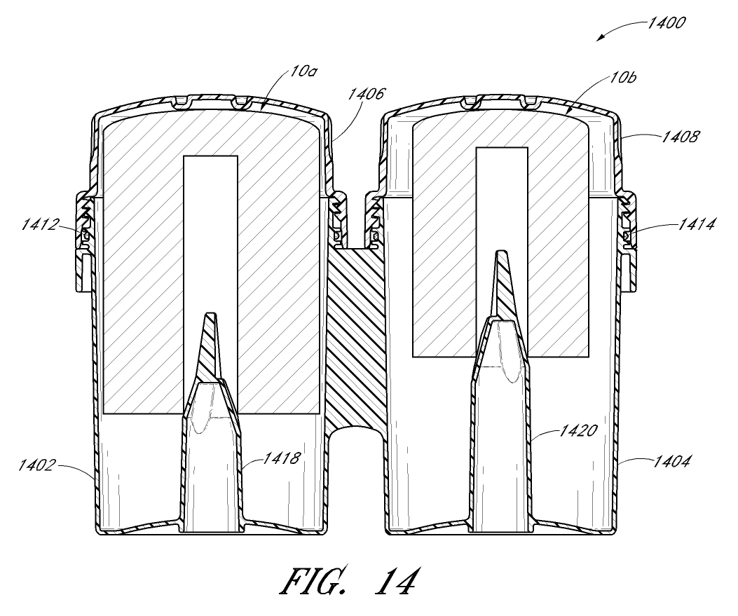

FIGS. 12A and 12B illustrate a filter recycling unit 1200 for draining fluid. The filter recycling unit 1200 comprises a reservoir and a filter positioning member. The reservoir comprises a fluid reservoir 1202 including a cavity. Fluid from a filter 10 is drainable into the cavity of the fluid reservoir 1202. The filter positioning member is capable of positioning a filter 10 in a substantially fixed relation with respect to the cavity to drain fluid from the filter 10 into the cavity. The filter positioning member comprises a magnet 1208 configured to magnetically engage a filter 10. As described above, the fluid recycling unit may further comprise threads and a sealing element 1206.

In certain embodiments, the magnet 1208 is integrated with a cover 1204 such that the magnet 1208 is configured to magnetically engage the top 12 of a filter 10 (e.g., as illustrated in FIG. 12A). During operation, a user may disengage a filter 10 from an engine with the top 12 down such that fluid remains within the filter 10. At that point, the user need not have any further direct physical contact with the filter 10. Holding the cover 1204, the user flips the filter 10 over and into the reservoir 1202. The user engages the cover 1204 with the reservoir 1202 such that the filter 10 is positioned in a substantially fixed relation with respect to the cavity to drain fluid from the filter 10 into the cavity of the reservoir 1202.

In certain embodiments, the magnet 1208 is integrated with the reservoir 1202 such that the magnet 1208 is configured to magnetically engage the cylindrical portion 14 of a filter 10 (e.g., as illustrated in FIG. 12B). During operation, a user may drop the filter 10 into the reservoir 1202, where the magnet 1208 will magnetically engage the filter 10 such that the filter 10 is positioned in a substantially fixed relation with respect to the cavity to drain fluid from the filter 10 into the cavity of the reservoir 1202. The filter recycling unit 1200 optionally comprises a cover 1204 to reduce spillage of fluid from the cavity in such embodiments.

Other positions of the magnet 1208 are also possible. For example, a pedestal, such as the pedestal 118 discussed above, may comprise a magnetic portion to magnetically engage the metal threads 22 of a filter 10. In some embodiments, the quantity of metal in the filter 10 is higher near the threads than in the metallic shell such that the magnetic force may act on more material than in the embodiments illustrated in FIGS. 12A and 12B. In some embodiments, the filter positioning member 1208 is configured such that a filter 10 at least partially positioned in the reservoir 1202 is tilted with respect to the bottom of the reservoir 1202. For example and without limitation, the filter positioning member 1208 may comprise a first magnet spaced from the bottom of the reservoir 1202 by a first distance and a second magnet spaced from the bottom of the reservoir 1202 by a second distance different that the first distance.

As fluid drains from the filter 10, the force of gravity acting on the filter 10 may become reduced because the mass of the filter 10 decreases. The magnetic force remains constant because the mass of the metallic shell remains the same. Thus, the magnet 1208 may advantageously have a stronger hold on the filter 10 as time passes.

FIG. 13 illustrates a filter recycling unit 1300 for draining fluid. The filter recycling unit 1300 comprises a reservoir and a filter positioning member. The reservoir comprises a fluid reservoir 1302 including a cavity. Fluid from a filter 10 is drainable into the cavity of the fluid reservoir 1302. The filter positioning member is capable of positioning a filter 10 in a substantially fixed relation with respect to the cavity to drain fluid from the filter 10 into the cavity. The filter positioning member 1108 comprises an interior portion of a sidewall of the reservoir 1102. For example, the filter positioning member 1308 illustrated in FIG. 13 comprises a plurality of ribs 1308. In certain embodiments, the ribs 1308 comprise annular members with inner diameters that increase or decrease along the length of the reservoir 1302. In some embodiments, the ribs 1308 comprise rubber or a rubber-like material. In some embodiments, the ribs 1308 are annular. In some embodiments, the ribs 1308 comprise a series of flexible tabs extending inwardly from a sidewall of the reservoir 1302. As a filter 10 is inserted into the reservoir 1302, at least some of the ribs 1308 engage the cylindrical portion 14 of the filter 10 such that the filter 10 is positioned in a substantially fixed relation with respect to the cavity to drain fluid from the filter 10 into the cavity of the reservoir 1302. For example, in the embodiment illustrated in FIG. 13, the filter 10 is positioned by the second ribs 1308. In some embodiments, at least some of the ribs 1308 are angled towards the bottom of the reservoir 1302. In certain such embodiments, fluid that drains from a positioned filter 10 onto ribs 1308 therebelow drains into the cavity of the reservoir 1302. In some embodiments, the filter positioning member 1308 is configured such that a filter 10 at least partially positioned in the reservoir 1302 is tilted with respect to the bottom of the reservoir 1302. For example and without limitation, the filter positioning member 1308 may comprise a first rib spaced from the bottom of the reservoir 1302 by a first distance and a second rib spaced from the bottom of the reservoir 1302 by a second distance different that the first distance.

The filter recycling unit 1300 optionally comprises a cover 1304 connectable to the reservoir 1302 to at least temporarily store a positioned filter 10 and configured to substantially preclude fluid drained into the reservoir 1302 from spilling. In certain such embodiments, the cover 1304 connected to the reservoir 1302 collectively defines a shape for the filter recycling unit 1300 similar to a filter. As described above, the fluid recycling unit may further comprise threads and a sealing element 1306.

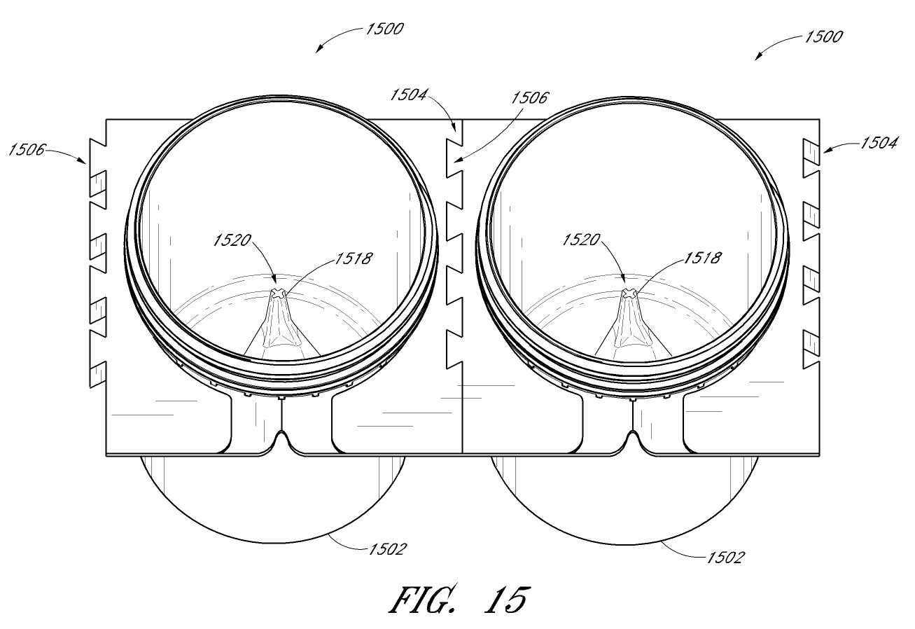

FIG. 14 illustrates a filter recycling unit 1400 for draining fluid. The filter recycling unit 1400 comprises a reservoir and a filter positioning member. The reservoir comprises a fluid reservoir 1402 including a cavity. Fluid from a filter 10 is drainable into the cavity of the fluid reservoir 1402. The filter positioning member is capable of positioning a filter 10 in a substantially fixed relation with respect to the cavity to drain fluid from the filter 10 into the cavity. The filter positioning member comprises pedestals 1418, 1420. In contrast to the embodiment illustrated in FIGS. 2-8, the pedestals 1418, 1420 have different sizes. Thus, the reservoir 1402 may engage a large filter 10a while the reservoir 1404 may engage a smaller filter 10b, the top 12 of each filter 10a, 10b being engaged by an inner surface of the cover 1406, 1408, respectively. In some embodiments, the pedestals 1418, 1420 are integrally formed with the reservoirs 1402, 1404. In certain alternative embodiments, the pedestals 1418, 1420 are modular such that a user may select a pedestal for the specific size of a filter 10. As described above, one or both of the reservoirs 1402, 1404 and filter positioning members 1418, 1420 can be configured such a filter 10 at least partially positioned in a reservoir 1402, 1404 is tilted with respect to the bottom of the reservoir 1402, 1404.

The filter recycling unit 1400 optionally comprises a cover 1404 connectable to the reservoir 1402 to at least temporarily store a positioned filter 10 and configured to substantially preclude fluid drained into the reservoir 1402 from spilling. In certain such embodiments, the cover 1404 connected to the reservoir 1402 collectively defines a shape for the filter recycling unit 1400 similar to a filter. As described above, the fluid recycling unit may further comprise threads and a sealing element 1406.

FIG. 15 illustrates a filter recycling unit 1500 for draining fluid. The filter recycling unit 1500 comprises a reservoir and a filter positioning member. The reservoir comprises a fluid reservoir 1502 including a cavity. Fluid from a filter 10 is drainable into the cavity of the fluid reservoir 1502. The filter positioning member is capable of positioning a filter 10 in a substantially fixed relation with respect to the cavity to drain fluid from the filter 10 into the cavity. The filter positioning member comprises a pedestal 1518. The illustrated pedestal 1518 comprises four channels 1520 that allow fluid to drain from the center hole 16 of a filter 10 into the cavity of the reservoir 1502. Other numbers of channels are also possible, as described above. As described above, the reservoir 1502 and filter positioning member 1518 can be configured such a filter 10 at least partially positioned in a reservoir 1502 is tilted with respect to the bottom of the reservoir 1502.

The filter recycling unit 1500 further comprises a plurality of engagement members 1504, 1506 (e.g., complementary engagement members 1504, 1506) configured to interlock the reservoir 1502 with another reservoir 1502 (e.g., as illustrated in FIG. 15). Although the engagement members 1504, 1506 illustrated in FIG. 15 are dovetailed, any variety of engagement members is possible. For example and without limitation, the engagement members of two reservoirs 1502 may be stacked one over the other similar to the edges of interlocking chairs. Other non-limiting examples include snap-locks and adhesive surfaces. A filter recycling unit for draining fluid that comprises engagement members advantageously allows users to buy a reservoir 1502 each time they perform an oil change or otherwise need to dispose of a filter 10, and then to couple it to previous and future reservoirs 1502. Additionally, the reservoir 1502 may contain different filter positioning members such that filter recycling units 1500 adapted to optimally house different sized filters 10 may be coupled to each other.

The filter recycling unit 1500 optionally comprises a cover 1504 connectable to the reservoir 1502 to at least temporarily store a positioned filter 10 and configured to substantially preclude fluid drained into the reservoir 1502 from spilling. In certain such embodiments, the cover 1504 connected to the reservoir 1502 collectively defines a shape for the filter recycling unit 1500 similar to a filter. As described above, the fluid recycling unit may further comprise threads and a sealing element 1506. Coupling a plurality of filter recycling units 1500 may enhance the stacking options, for example as described above with respect to FIGS. 11A-11E.

FIG. 16 illustrates an alternative embodiment of a cover or cap 1600 compatible with certain filter recycling units for draining fluid disclosed herein. The cover 1600 does not comprise threads or dimples, and is configured to engage a plurality of fluid reservoirs. In some embodiments, the cover 1600 is configured to snap onto fluid reservoirs. In certain alternative embodiments, the cover 1600 is configured to be clamped onto fluid reservoirs. Other embodiments are also possible. A cover 1600 that is configured to engage only one reservoir without threads and/or dimples is also possible. In some embodiments, the cover 1600 comprises the magnetic filter positioning member 1208 described with respect to FIG. 12A.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a reading of the claims that follow.

1. A filter recycling unit comprising:
a reservoir defining a cavity capable of storing fluid and at least a portion of a filter;
at least one filter positioning member capable of positioning the filter at least partially within the cavity to drain fluid from the positioned filter into the reservoir; and
a cover operably connectable to the reservoir, the cover configured to at least temporarily store the positioned filter and configured to substantially preclude the drained fluid in the reservoir from spilling during movement of the unit, wherein the cover connected to the reservoir collectively defines a shape for the unit substantially similar to the filter.

2. The unit of claim 1, wherein the cover includes an upper surface and the reservoir includes a lower surface, and wherein the upper surface of a first said unit cooperates with the lower surface of a second said unit to form a stable stack of said first and second units.

3. The unit of claim 1, further comprising:
a second reservoir defining a second cavity capable of storing fluid and at least a portion of a second filter;
at least one second filter positioning member capable of positioning the second filter at least partially within the second cavity to drain fluid from the positioned second filter into the second reservoir; and a connecting member configured to couple the reservoir to the second reservoir.

4. The unit of claim 3, wherein the cover includes an upper surface, the reservoir includes a lower surface, and the second reservoir includes a lower surface, and wherein the upper surfaces of a first said unit cooperates with the lower surfaces of a second said unit to form a stable stack of said first and second units.

5. The unit of claim 3, further comprising a second cover operably connectable to the second reservoir, the second cover configured to at least temporarily store the positioned second filter and configured to substantially preclude the drained fluid in the second reservoir from spilling during movement of the unit.

6. The unit of claim 5, wherein the cover includes an upper surface, the second cover includes an upper surface, the reservoir includes a lower surface, and the second reservoir includes a lower surface, the upper surfaces of a first said unit configured to cooperate with the lower surfaces of a second said unit such that a plurality of said units are stackable.

7. The unit of claim 6, wherein a plurality of stacked units comprises an orientation, the orientation including:
the upper surface of the cover of a first said unit cooperates with the lower surface of the reservoir of a second said unit;
the upper surface of the second cover of the first said unit cooperates with the lower surface of the second reservoir of the second said unit;
the upper surface of the cover of a third said unit cooperates with the lower surface of the reservoir of a fourth said unit; and
the upper surface of the second cover of the third said unit cooperates with the lower surface of the second reservoir of the fourth said unit.

8. The unit of claim 4, wherein a plurality of stacked units comprises an orientation, the orientation including:
the upper surface of the cover of a first said unit cooperates with the lower surface of the reservoir of a second said unit;
the upper surface of the second cover of the first said unit cooperates with the lower surface of the reservoir of a third said unit;
the upper surface of the cover of a fourth said unit cooperates with the lower surface of the second reservoir of the second said unit; and
the upper surface of the second cover of the fourth said unit cooperates with the lower surface of the second reservoir of the third said unit.

9. The unit of claim 3, wherein the reservoir and the second reservoir are shaped to substantially preclude transfer of the fluid drained from the filter and the fluid drained from the second filter between the reservoir and the second reservoir.

10. The unit of claim 3, wherein the reservoir and the second reservoir are shaped to permit transfer of the fluid drained from the filter and the fluid drained from the second filter between the reservoir and the second reservoir.

11. The unit of claim 1, wherein the shape is similar to a single filter.

12. The unit of claim 1, wherein a volume of the cavity is less than a volume of a filter capable of being at least partially stored in the reservoir.

13. The unit of claim 12, wherein a volume of the cavity is between about 30% and 70% of a volume of a filter capable of being at least partially stored in the reservoir.

14. The unit of claim 12, wherein a volume of the cavity is less than about 65% of a volume of a filter capable of being at least partially stored in the reservoir.

15. The unit of claim 1, wherein the at least one positioning member comprises a pedestal configured to be at least partially inserted in a center hole of a positioned filter.

16. The unit of claim 13, wherein the pedestal comprises a frustro-conical portion including a plurality of channels, fluid from a filter positioned on the pedestal capable of flowing through the plurality of channels into the reservoir.

17. The unit of claim 13, wherein a filter positioned on the pedestal is substantially fixed with respect to the reservoir.

18. The unit of claim 13, wherein a bottom of a filter positioned on the pedestal is substantially non-parallel to a bottom of the reservoir.

19. The unit of claim 16, wherein the pedestal is substantially perpendicular to the bottom of the reservoir.

20. (canceled)

21. The unit of claim 1, wherein the reservoir is configured to at least partially store at least about 90% of all filters manufactured for light and medium duty cars and trucks.

22. (canceled)

23. The unit of claim 1, wherein the reservoir comprises plastic.

24. (canceled)

25. The unit of claim 1, further comprising a sealing element between the reservoir and the cover.

26. A filter recycling unit comprising:
a first substantially cylindrical reservoir defining a first cavity capable of storing fluid and at least a portion of a first filter, the first reservoir including an open top and external threads;
a first pedestal configured to be at least partially inserted into a center hole of the first filter to drain the fluid from the first filter, the first pedestal extending within the first cavity and including a frustro-conical portion including a plurality of fluid channels, the fluid channels configured to direct the fluid from the first filter positioned by the first pedestal into the first reservoir;
a first substantially cylindrical cover including an open bottom and internal threads that operably engage the external threads of the first reservoir;
a first sealing member disposed between the first reservoir and the first cover, the first sealing member substantially precluding fluid drained into the first reservoir from flowing out of the open top of the first reservoir when the first cover is engaged with the first reservoir;
a second substantially cylindrical reservoir defining a second cavity capable of storing fluid and at least a portion of a second filter, the second reservoir including an open top and external threads;
a connecting member coupling the first reservoir to the second reservoir;
a second pedestal configured to be at least partially inserted into a center hole of the second filter to drain the fluid from the second filter, the second pedestal extending within the second cavity and including a frustro-conical portion including a plurality of fluid channels, the fluid channels configured to direct the fluid from the second filter positioned by the second pedestal into the second reservoir;
a second substantially cylindrical cover including an open bottom and internal threads that operably engage the external threads of the second reservoir;
a second sealing member disposed between the second reservoir and the second cover, the second sealing member substantially precluding fluid drained into the second reservoir from flowing out of the open top of the second reservoir when the second cover is engaged with the second reservoir;

27. The unit of claim 26, wherein the first reservoir and the second reservoir are separated.

28. The unit of claim 26, wherein the first reservoir and the second reservoir are in fluid communication.
